(19) United States
(12) Patent Application Publication
(10) Pub. No.: US 2004/0174853 A1
(43) Pub. Date: Sep. 9, 2004

(54) Communication control program, content delivery program, terminal, and content server

(75) Inventors: Takeshi Saito, Kawasaki (JP); Ikuo Takekawa, Kawasaki (JP); Satoru Chikuma, Kawasaki (JP); Morihisa Kawai, Kawasaki (JP); Teruhiko Onishi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/790,935

(22) Filed: Mar. 2, 2004

(30) Foreign Application Priority Data
Mar. 7, 2003 (JP) 2003-061953

(51) Int. Cl. H04Q 7/24; H04J 3/24

(52) U.S. Cl. 370/338; 370/349

(57) ABSTRACT

A communication control program which can change quality of received data according to variations in communication conditions associated with change of a network used in communication. In accordance with the communication control program, a terminal detects at least one of a plurality of network interfaces which is currently available for communication, determines a network interface having the highest priority among the at least one of the plurality of network interfaces by referring to an interface information table, and performs data communication through the determined network interface. In addition, the terminal notifies a content server of a bandwidth of the determined network interface. Then, the content server determines quality of content to be delivered to the terminal, generates the content with the determined quality, and transmits the content to the terminal.

### BACKGROUND OF THE INVENTION

1) Field of the Invention

The present invention relates to a communication control program, a content delivery program, a terminal, and a content server for performing data communication in mobile environment, in particular, through a plurality of networks.

2) Description of the Related Art

With the widespread of use of computer networks, demands for environment which realizes mobile communication and enables connection to a network anytime anywhere are increasing. In such circumstances, systems realizing connection to a network through a wireless path are widely used.

In recent years, the functions of mobile terminals have been improved, and devices which enable a single terminal to be connected to a plurality of networks such as a wireless LAN, a wired LAN, a mobile telephone network, and a PHS (personal handyphone system) network are already commercialized. In the case where a terminal can be connected to a plurality of networks, the terminal can select an optimum communication environment every time the terminal performs communication. In such circumstances, a technique for handover (switching of a base station) between different networks is nearing realization. For example, Windows 2000 (which is a trademark of Microsoft Corporation) has a function called Media Sense, so that Windows 2000 can perform communication by detecting at least one available communication medium among a plurality of communication mediums, and selecting one of the at least one available communication medium for communication. For example, see the following information on the Internet:

(1) “Windows 2000 TCP/IP,” published in 1985 to 2001 by Microsoft Corporation on the Internet at the URL: http://www.microsoft.com/windows2000/techinfo/reskit/en-us/default.asp?url=/windows2000/techinfo/reskit/en-us/cnet/cnbc_imp_vznc.asp;

(2) “Wireless LAN Technology and Windows XP,” published in 2003 by Microsoft Corporation at the URL: http://www.microsoft.com/japan/technet/treeview/default.as p?url=/japan/technet/prodtechnol/winxppro/evaluate/wrlsxp. asp; and

(3) “Mobile Computing of Windows XP,” published in 2003 by Microsoft Corporation at the URL: http://www.microsoft.com/japan/technet/treeview/default.as p?url=/japan/technet/prodtechnol/winxppro/evaluate/mblxp.a sp.

The above three information on the Internet was referred to by the present applicants on Feb. 27, 2003.

However, the communication bandwidths of mobile terminals are instable. In a technique which has been proposed (e.g., as disclosed in Japanese Unexamined Patent Publication No. 2000-270015, FIG. 1) for solving the above problem, a communication bandwidth of a wireless terminal is dynamically determined, and a content file corresponding to the determined bandwidth is transmitted from a server computer to the wireless terminal.

Incidentally, with the widespread use of mobile terminals, various services for use with the mobile terminals have been provided. An increasing number of services provided for use with the mobile terminals have a feature that a great communication bandwidth is used for delivery of sound and moving images.

Nevertheless, the communication bandwidths greatly vary depending on networks to which the terminals are connected. Therefore, even if a wired LAN is optimum for transmission of certain data, the data may not be successfully displayed through a low-speed wireless line such as PHS. Thus, for example, in the current services for delivery of moving images, data in different forms respectively adapted to bandwidths of various types of destinations such as personal computers, mobile terminals, and the like are prepared and separately delivered to the destinations.

When the technique disclosed in Japanese Unexamined Patent Publication No. 2000-270015 is used, a content file corresponding to the bandwidth of each mobile terminal can be transmitted. Nevertheless, even in this case, it is necessary to prepare a plurality of content items corresponding to different bandwidths and being accessed by a common address.

In systems, such as the Internet, in which content is provided to communication devices which are improving day be day, it is difficult to prepare a great number of content items (having different data volumes) corresponding to communication environments of all types of terminals and containing substantially identical information. In particular, in the case of content which is delivered on a real-time basis, it is impossible to prepare and hold the content in advance as in the technique disclosed in Japanese Unexamined Patent Publication No. 2000-270015.

### SUMMARY OF THE INVENTION

The present invention is made in view of the above problems, and the object of the present invention is to provide a mobile terminal which can change quality of received data according to variations in communication conditions associated with switching of a network through which communication is performed.

In order to accomplish the above object, a communication control program which is executed by a computer and makes the computer perform a process for performing communication by use of a plurality of network interfaces, where the process comprises the steps of: (a) detecting at least one of the plurality of network interfaces which is currently available for communication; (b) determining a network interface having the highest priority among the at least one of the plurality of network interfaces by referring to an interface information table in which numerical values related to a predetermined attribute of the plurality of network interfaces are set, and recognizing at least one priority of the at least one of the plurality of network interfaces based on the numerical values; and (c) performing data communication through the network interface determined in step (b).

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the present invention which is realized in embodiments;

FIG. 2 is a diagram illustrating an example of a system in which a first embodiment of the present invention is used;

FIG. 3 is a diagram illustrating an example of a hardware construction realizing the terminals in the embodiments of the present invention;

FIG. 4 is a block diagram illustrating functions of a system of the first embodiment of the present invention;

FIG. 5 is a diagram illustrating an example of a data structure of a medium information table;

FIG. 6 is a flow diagram illustrating a sequence of processing for determining an optimum medium;

FIG. 7 is a block diagram illustrating functions of a system of a second embodiment of the present invention;

FIG. 8 is a diagram illustrating an example of measurement of an effective transfer rate;

FIG. 9 is a block diagram illustrating functions of a system of a third embodiment of the present invention;

FIG. 10 is a diagram illustrating an example of a protocol for notification of a bandwidth;

FIG. 11 is a diagram illustrating an example of quality conversion of moving-image data according to the bandwidth;

FIG. 12 is a flow diagram illustrating a sequence of processing for registering information on a terminal as a destination;

FIG. 13 is a flow diagram illustrating a sequence of processing for conversion of image data;

FIG. 14 is a block diagram illustrating functions of a system of a fourth embodiment of the present invention;

FIG. 15 is a block diagram illustrating functions of a system of a fifth embodiment of the present invention;

FIG. 16 is a block diagram illustrating functions of a VoIP system in which a dynamic content conversion function is used;

FIG. 17 is a diagram illustrating a sound conversion function in a sound transmission unit;

FIG. 18 is a flow diagram illustrating a sequence of processing for generating sound data;

FIG. 19 is a diagram illustrating an example of conversion of waveform data;

FIG. 20 is a block diagram illustrating functions of a system of a sixth embodiment of the present invention;

FIG. 21 is a block diagram illustrating functions of a system of a seventh embodiment of the present invention;

FIG. 22 is a block diagram illustrating functions of a system of an eighth embodiment of the present invention;

FIG. 23 is a diagram illustrating an example of a data structure of a map-object priority table;

FIG. 24 is a diagram illustrating an example of generation of map data which has quality corresponding; to a bandwidth;

FIG. 25 is a flow diagram illustrating a sequence of processing for generating map data;

FIG. 26 is a block diagram illustrating functions of a system of a ninth embodiment of the present invention; and

FIG. 27 is a block diagram illustrating functions of a system of a tenth embodiment of the present invention.

### DESCRIPTION OF THE PREFERRED EMBODIMENTS

Embodiments of the present invention are explained below with reference to drawings.

First, an outline of the present invention which is realized in the embodiments is explained, and thereafter details of the embodiments are explained.

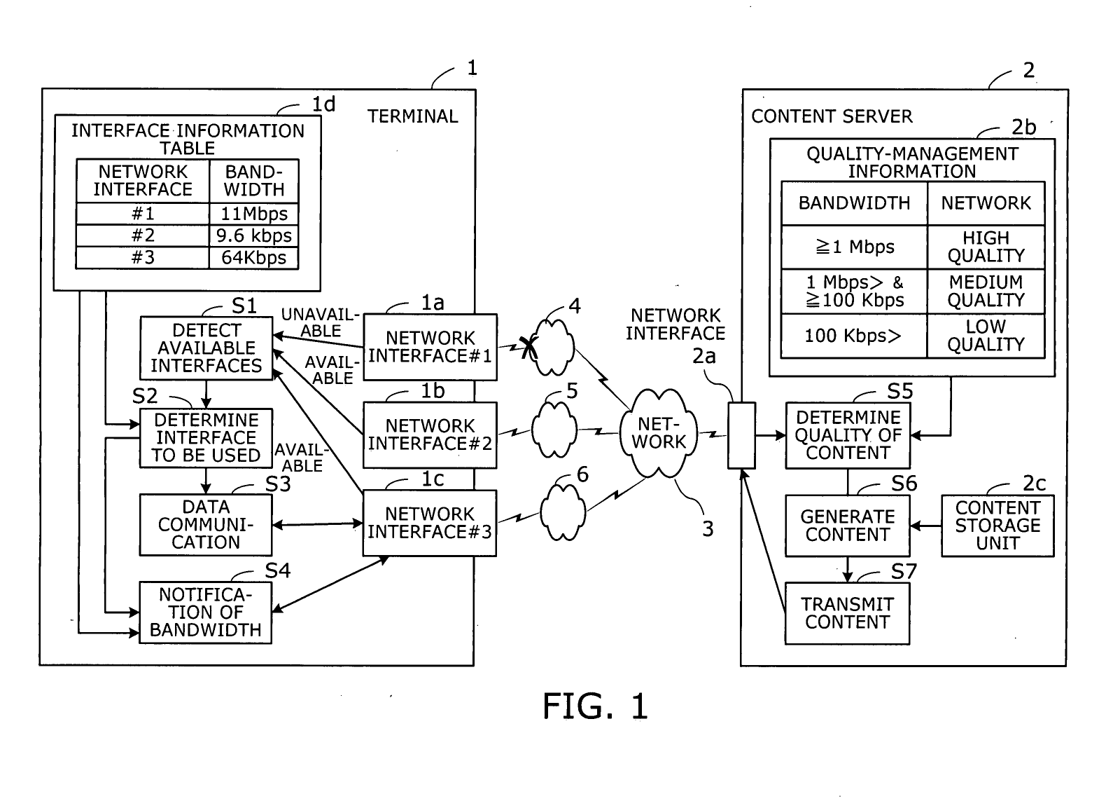

FIG. 1 is a conceptual diagram illustrating the present invention which is realized in the embodiments. As illustrated in FIG. 1, the present invention can be applied to data communications between a terminal 1 and a content server 2 through networks 3 through 6. In the example of FIG. 1, the network 3 is connected to the other networks 4 through 6.

The terminal 1 is, for example, a mobile terminal. The terminal 1 comprises a plurality of network interfaces 1a, 1b, and 1c. The network interface 1a, to which an identifier “#1” is assigned, can be connected to the network 4. The network interface 1b, to which an identifier “#2” is assigned, can be connected to the network 5. The network interface 1c, to which an identifier “#3” is assigned, can be connected to the network 6. The terminal 1 can switch a network which the terminal 1 uses, while maintaining a communication session.

In addition, an interface information table 1d is provided in advance in the terminal 1, and values related to a predetermined attribute of the respective network interfaces 1a, 1b, and 1c are set in the interface information table 1d. The predetermined attribute is, for example, a bandwidth. In the example of FIG. 1, the bandwidth through the network interface 1a having the identifier “#1” is 11 Mbps, the bandwidth through the network interface 1b having the identifier “#2” is 9.6 Kbps, and the bandwidth through the network interface 1c having the identifier “#3” is 64 Kbps.

When communication between the terminal 1 and content server 2 is started, or when a communication condition is changed, the terminal 1 performs the following processing. For example, the communication condition is changed when communication through a network interface which has been impossible becomes possible, or when a condition of communication through a currently using network interface deteriorates.

First, the terminal 1 detects at least one of the network interfaces 1a, 1b, and 1c through which communication is possible (in step S1). For example, in the example of FIG. 1, it is impossible to perform communication through the network interface 1a, and possible to perform communication through the network interface 1b or 1c.

Next, the terminal 1 refers to the interface information table 1d, recognizes the priorities of the network interfaces 1b and 1c through which communication is possible, based on the values related to the attribute, and determines one of the network interfaces which has the highest priority (in step S2). For example, in the case where network interfaces having greater bandwidths (higher data transmission rates) have higher priorities, the network interface 1c having the identifier “#3” has the highest priority.

The terminal 1 performs data communication through the determined network interface 1c (in step S3).

As described above, when it is possible to perform communication through a plurality of network interfaces, one of the plurality of interfaces which has the highest priority is automatically determined, and data communication is performed through the determined network interface.

In addition, the terminal 1 acquires from the interface information table 1d the value related to the attribute (e.g., the bandwidth) of the determined network interface 1c, and transmits the acquired value to the content server 2 (in step S4).

The content server 2 can be connected to the network 3 through a network interface 2a, and holds quality-management information 2b, which is a database indicating a relationship between the bandwidth and the quality of content. In the example of FIG. 1, the quality of content is “high quality” when the bandwidth is “1 Mbps or higher,” “medium quality” when the bandwidth is “lower than 1 Mbps and not lower than 100 Kbps,” and “low quality” when the bandwidth is “lower than 100 Kbps.”

When the content server 2 receives bandwidth data indicating the bandwidth through a network to which the terminal 1 is connected, the content server 2 determines the quality of content to be delivered to the terminal 1, by referring to the quality-management information 2b (in step S5). For example, the content server 2 is notified that the bandwidth through the network interface 1c is 64 Kbps, the content server 2 determines the quality of content to be “medium quality.”

Next (in step S6), the content server 2 generates a content item having quality determined in step S5. For example, in the case of image data, the quality can be adjusted based on the compression rate. Then, the content server 2 transmits the content having the quality corresponding to the bandwidth through the network which is used by the terminal 1.

Hereinbelow, the embodiments of the present invention are explained in detail. In the following explanations, information transmission mediums including networks are called mediums.

[First Embodiment]

In the first embodiment, when it is possible to perform communications through a plurality of network interfaces, one of the plurality of network interfaces having the highest priority is selected based on information which is preset, and data communication is performed by using the selected network interface.

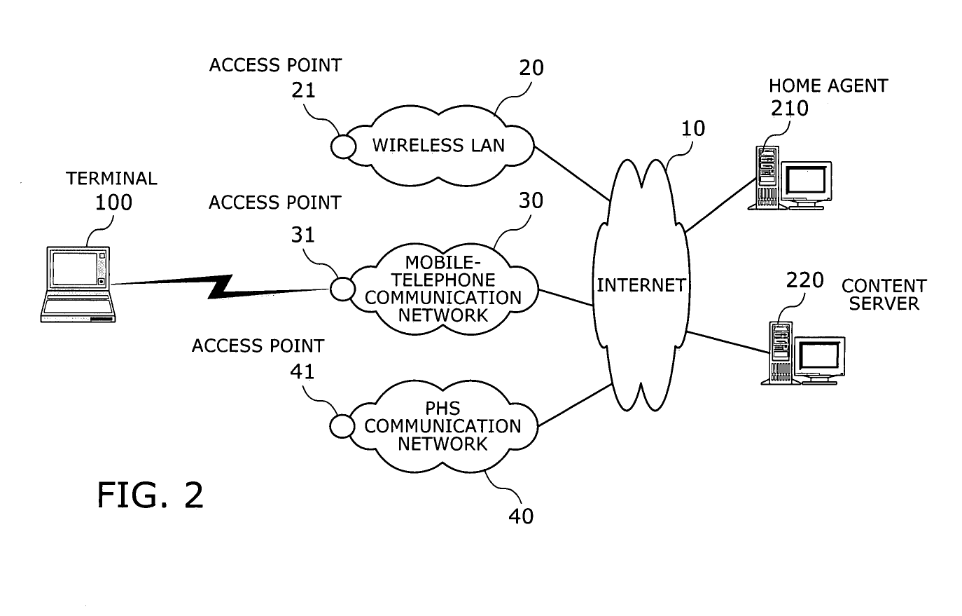

FIG. 2 is a diagram illustrating an exemplary construction of a system in the first embodiment of the present invention. In the construction illustrated in FIG. 2, the terminal 100 acquires content from a content server 220. The content server 220 is connected to the Internet 10, and delivers content through the Internet 10. A home agent 210, which is a router for relaying packets between the terminal 100 and the content server 200, is connected to the Internet 10.

In addition, various communication networks, e.g., a wireless LAN 20, a mobile-telephone communication network 30, and a PHS communication network 40, are connected to the Internet 10. Access points 21, 31, and 41 are provided in the wireless LAN 20, the mobile-telephone communication network 30, and the PHS communication network 40, respectively, so that the terminal 100 can be connected to the wireless LAN 20, the mobile-telephone communication network 30, and the PHS communication network 40 by wireless.

The terminal 100 comprises a plurality of network interfaces which enable connection to the wireless LAN 20, the mobile-telephone communication network 30, and the PHS communication network 40, respectively.

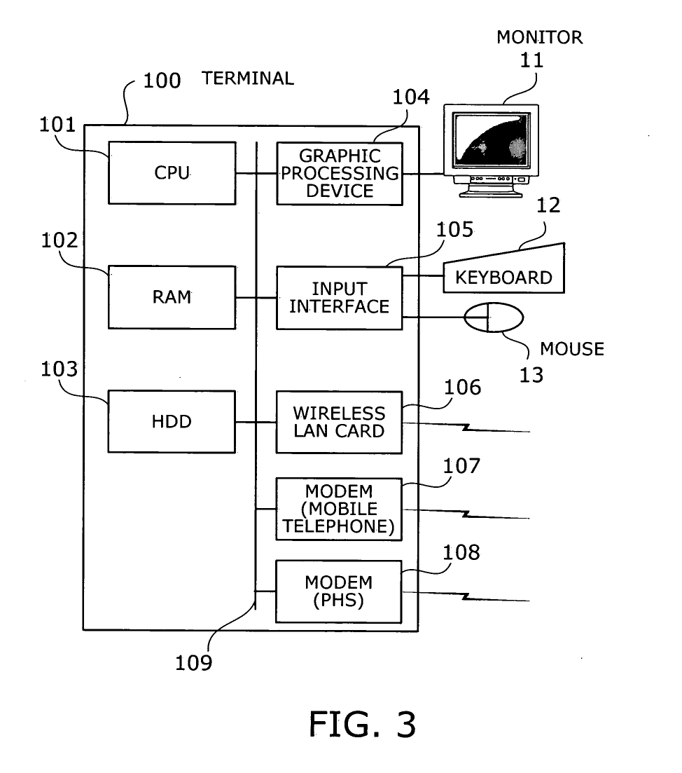

FIG. 3 is a diagram illustrating an example of a hardware construction realizing the terminals in the embodiments of the present invention. The entire system of the terminal 100 is controlled by a CPU (central processing unit) 101, to which a RAM (random access memory) 102, an HDD (hard disk drive) 103, a graphic processing device 104, an input interface 105, a wireless LAN card 106, a modem 107 for mobile telephone, a modem 108 for PHS are connected through a bus 109.

The RAM 102 temporarily stores at least portions of an OS (operating system) program and application programs which are executed by the CPU 101, as well as various types of data necessary for processing by the CPU 101. The HDD 103 stores the OS and application programs.

A monitor 11 is connected to the graphic processing device 104, which makes the monitor 11 display an image on a screen in accordance with an instruction from the CPU 101. A keyboard 12 and a mouse 13 are connected to the input interface 105, which transmits signals sent from the keyboard 12 and the mouse 13, to the CPU 101 through the bus 109.

The wireless LAN card 106 is a network interface which can be connected to the wireless LAN 20 by wireless communication with the access point 21. The modem 107 for mobile telephone is a network interface which can be connected to the mobile-telephone communication network 30 by wireless communication with the access point 31. The modem 108 for PHS is a network interface which can be connected to the PHS communication network 40 by wireless communication with the access point 41.

By using the above hardware construction, it is possible to realize processing functions in the embodiments of the present invention. Although FIG. 3 shows a hardware construction of the terminal 100, each of the home agent 210 and the content server 220 can also be realized by using a similar hardware construction, except that the network communication function which each of the home agent 210 and the content server 220 is required to have is only a network interface which enables connection with the Internet 10.

Next, the functions of the network in the first embodiment of the present invention are explained.

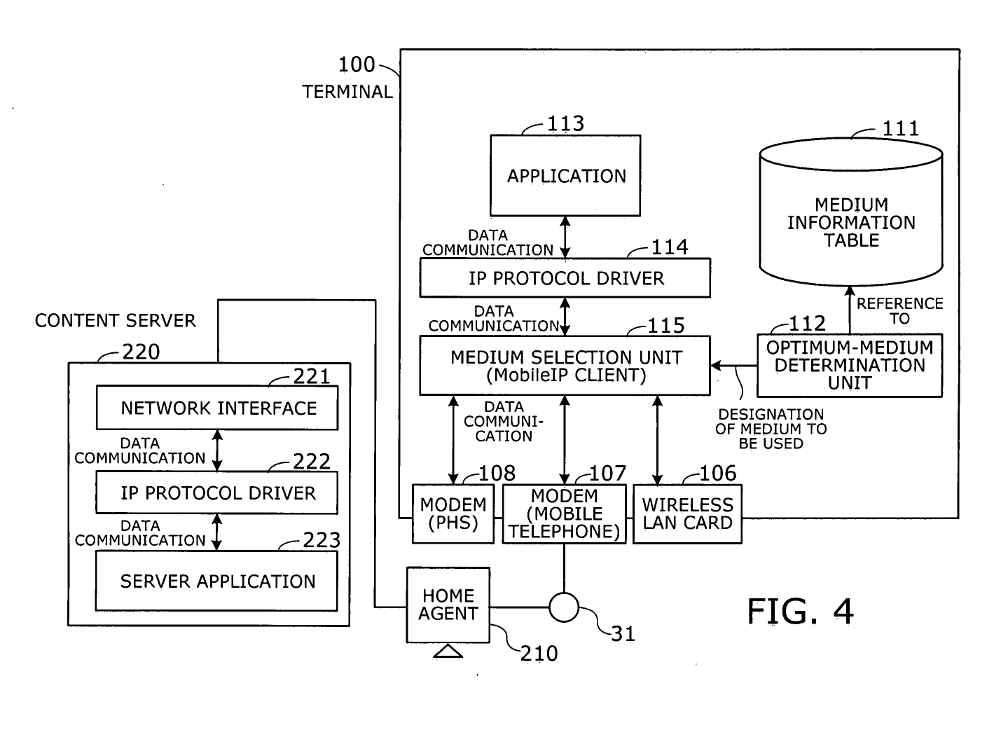

FIG. 4 is a block diagram illustrating functions of the system of the first embodiment. The terminal 100 comprises a medium information table 111, an optimum-medium determination unit 112, an application 113, an IP protocol driver 114, and a medium selection unit 115.

The medium information table 111 is a database which stores criteria for selection of a network used in data communication and data necessary for determination, where the criteria and the data are obtained through a plurality of networks through which the terminal 100 can perform communication.

The optimum-medium determination unit 112 monitors communication conditions of the respective networks, and determines a network which is optimum at the time of the determination, based on the contents of the medium information table 111.

The application 113 performs data communication with the IP protocol driver 114 in response to user's manipulation inputs and the like, and processing for requesting a content item from the content server 220 and displaying acquired content item on the screen.

The IP protocol driver 114 controls data communication in accordance with the IP protocol in response to requests from the application 113.

The medium selection unit 115 selects one of a plurality of network interfaces which is to be used in data communication, and performs the data communication through the selected network interface. The medium selection unit 115 has functions of a MobileIP client, and is realized by using the functions of the Media Sense used in Windows 2000 (trademark) or the like.

The content server 220 comprises a network interface 221, an IP protocol driver 222, and a server application 223.

The content server 220 performs data communication through the network interface 221 and the Internet 10. The IP protocol driver 222 controls data communication in accordance with the IP protocol. The server application 223 provides content items in response to requests from the application 113 in the terminal 100 and the like.

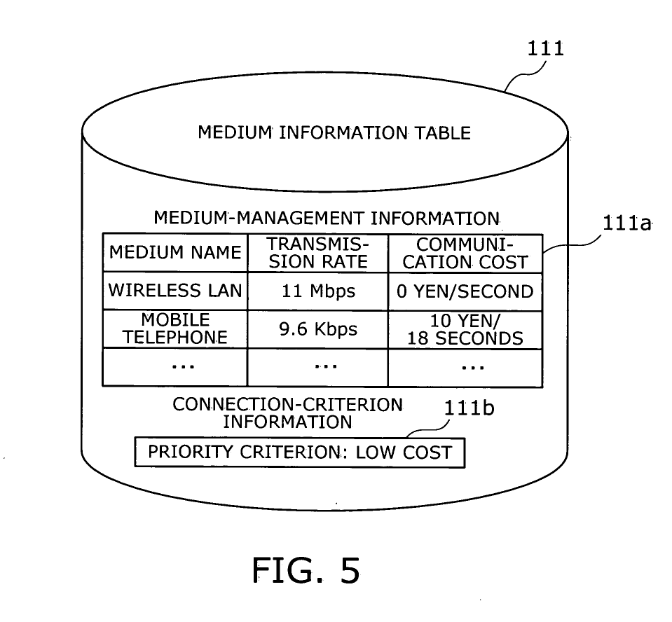

FIG. 5 is a diagram illustrating an example of the data structure of the medium information table 111. The medium information table 111 stores medium-management information 111a and connection-criterion information 111b.

The medium-management information 111a is a database in which transmission rates (bandwidths) and communication costs of networks (mediums) through which the terminal 100 can perform communication are registered. As illustrated in FIG. 5, the medium-management information 111a includes the items of the medium name, the transmission rate, and the communication cost, and the information items tabulated in each row are related to each other.

In the field of the medium name, names of mediums to which the terminal 100 can be connected are registered. In the field of the transmission rate, the transmission rates predetermined for the corresponding mediums are registered. In the field of the communication cost, a communication cost which occurs when the terminal 100 performs communication through each medium is registered. For example, in the case of the wireless LAN, the transmission rate is 11 Mbps, and the communication cost is 0 yen per second. That is, the communication cost of use of the wireless LAN is small. In addition, in the case of the mobile telephone, the transmission rate of the mobile telephone is 9.6 Kbps, and the communication cost is 10 yen per 18 seconds.

The connection-criterion information 111b is information indicating criteria for selection of a medium to which the terminal 100 is to be connected. In the example of FIG. 5, the connection-criterion information 111b indicates “LOW COST” as the priority criterion. That is, a medium which enables communication at the lowest cost is selected from among mediums to which the terminal 100 can be connected. In the selection of the medium, the field of the communication cost in the medium-management information 111a is referred to.

In the system having the above functions, the following processing is performed.

When communication is started, first, the medium selection unit 115 selects a medium through which the terminal 100 can perform communication. Specifically, the medium selection unit 115 determines whether or not the wireless LAN card 106, the modem 107 for mobile telephone, and the modem 108 for PHS can perform communication with the corresponding access points, respectively. Then, the medium selection unit 115 passes to the optimum-medium determination unit 112 information indicating at least one medium through which the terminal 100 can perform communication.

The optimum-medium determination unit 112 determines an optimum medium for communication, among the at least one medium through which the terminal 100 can perform communication. The determination of the optimum medium is made based on the information registered in the medium information table 111. The optimum-medium determination unit 112 notifies the medium selection unit 115 of the determined optimum medium. The medium selection unit 115 determines a network interface corresponding to the determined optimum medium to be a data communication path.

Thereafter, when the application 113 outputs to the IP protocol driver 114 a request for acquisition of a content item from the content server 220 in response to a user's manipulation input, the IP protocol driver 114 generates an IP packet, and passes the generated IP packet to the medium selection unit 115. Then, the medium selection unit 115 transmits the IP packet through the network interface which is determined to be the optimum medium as mentioned before. In the following explanations, it is assumed that the medium selection unit 115 transmits the IP packet through the modem 107 for mobile telephone.

The IP packet transmitted from the modem 107 for mobile telephone is received at the access point 31, and is then passed to the home agent 210, which transfers the received IP packet to the content server 220.

The content server 220 receives the IP packet at the network interface 221, which passes the IP packet to the IP protocol driver 222. The IP protocol driver 222 interprets the contents of the received IP packet, and passes to the server application 223 data (representing the request for acquisition of the content item) contained in the IP packet transferred as above.

The server application 223 passes the content item to the IP protocol driver 222 in response to the request for acquisition of the content item. Then, the IP protocol driver 222 generates an IP packet containing the content item, and passes the IP packet to the network interface 221, which transmits the IP packet to the home agent 210.

The home agent 210 transfers the IP packet to the terminal 100 through the access point 31.

In the terminal 100, the modem 107 for mobile telephone receives the IP packet, and passes the IP packet to the IP protocol driver 114 through the medium selection unit 115. The IP protocol driver 114 extracts the content item from the received IP packet, and passes the content item to the application 113, which processes the received content item (e.g., displays the content item on the screen) in accordance with a user's instruction.

When the available medium (network) changes, the change is detected by the optimum-medium determination unit 112. Then, the optimum-medium determination unit 112 newly determines an optimum medium, and notifies the medium selection unit 115 of the newly determined optimum medium. In response to the notification, the medium selection unit 115 switches the connection path to the newly determined optimum medium.

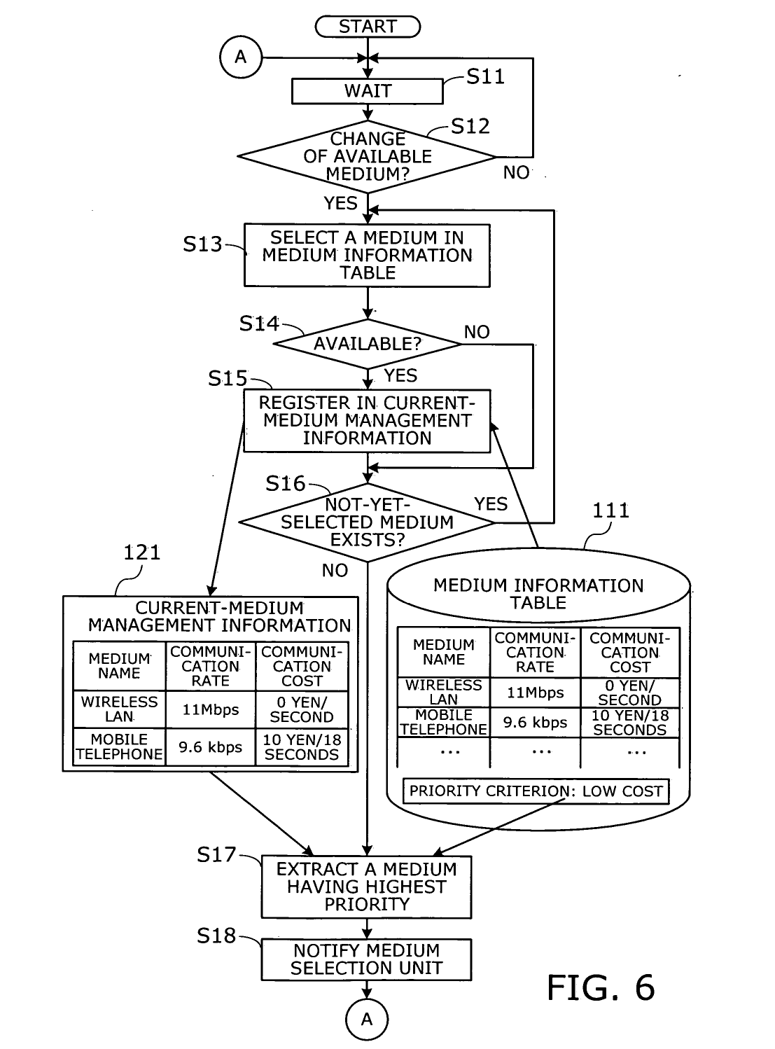

FIG. 6 is a flow diagram illustrating a sequence of processing for determining an optimum medium. The processing illustrated in FIG. 6 is explained below step by step.

[Step S11] The optimum-medium determination unit 112 waits for reception of information on a change of at least one available medium.

[Step S12] When at least one available medium changes (i.e., when a new medium becomes available, or when a medium which has been available becomes unavailable), the operation goes to step S13. When there is no change in the at least one available medium, the operation goes to step S11, and the optimum-medium determination unit 112 waits for reception of information on a change of the at least one available medium.

[Step S13] The optimum-medium determination unit 112 selects one of the names of mediums in the medium information table 111.

[Step S14] The optimum-medium determination unit 112 determines whether or not a medium corresponding to the selected name is available. The usability of each medium is determined based on the aforementioned information passed from the medium selection unit 115. When the medium corresponding to the selected name is determined to be available, the operation goes to step S15. When the medium corresponding to the selected name is determined to be unavailable, the operation goes to step S16.

[Step S15] The optimum-medium determination unit 112 adds to current-medium management information 121 information which is registered in the medium information table 111 in association with the selected name. The current-medium management information 121 is an information table arranged in the optimum-medium determination unit 112, and has a data structure similar to the medium-management information 111a, which has the data structure as illustrated in FIG. 5.

[Step S16] The optimum-medium determination unit 112 determines whether or not the medium information table 111 contains at least one name of a medium which is currently not selected. When yes is determined in step S16, the operation goes to step S13, and one of the at least one name determined as above is selected. When no is determined in step S16, the operation goes to step S17.

[Step S17] The optimum-medium determination unit 112 extracts a name of a medium having the highest priority from among at least one name of at least one medium registered in the current-medium management information 121. Specifically, the optimum-medium determination unit 112 refers to the connection-reference information 111b in the medium information table 111, and acquires a priority criterion. Next, the optimum-medium determination unit 112 assigns priorities to the at least one medium registered in the current-medium management information 121, based on the priority criterion, and then extracts a medium to which the highest priority is assigned.

For example, in the example of FIG. 6, the priority criterion is “low price.” At this time, two mediums “wireless LAN” and “mobile telephone” are registered in the current-medium management information 121. In this case, the optimum-medium determination unit 112 refers to the field of the communication cost, and selects a medium corresponding to the lowest cost. Since, in the example of FIG. 6, the communication cost of the wireless LAN is 0 yen per second, the wireless LAN is selected.

[Step S18] The optimum-medium determination unit 112 notifies the medium selection unit 115 of the name of the extracted medium, and thereafter the operation goes to step S11.

As explained above, a medium is automatically selected based on the priorities. Therefore, users are not required to make a manipulation input for switching a medium (network), i.e., the operability is improved. In addition, since the users are not required to determine the optimum medium, the users can continue communication without awareness of switching of the medium.

[Second Embodiment]

The second embodiment is explained below. In the second embodiment, an optimum medium is selected based on an effective transfer rate through each medium (network).

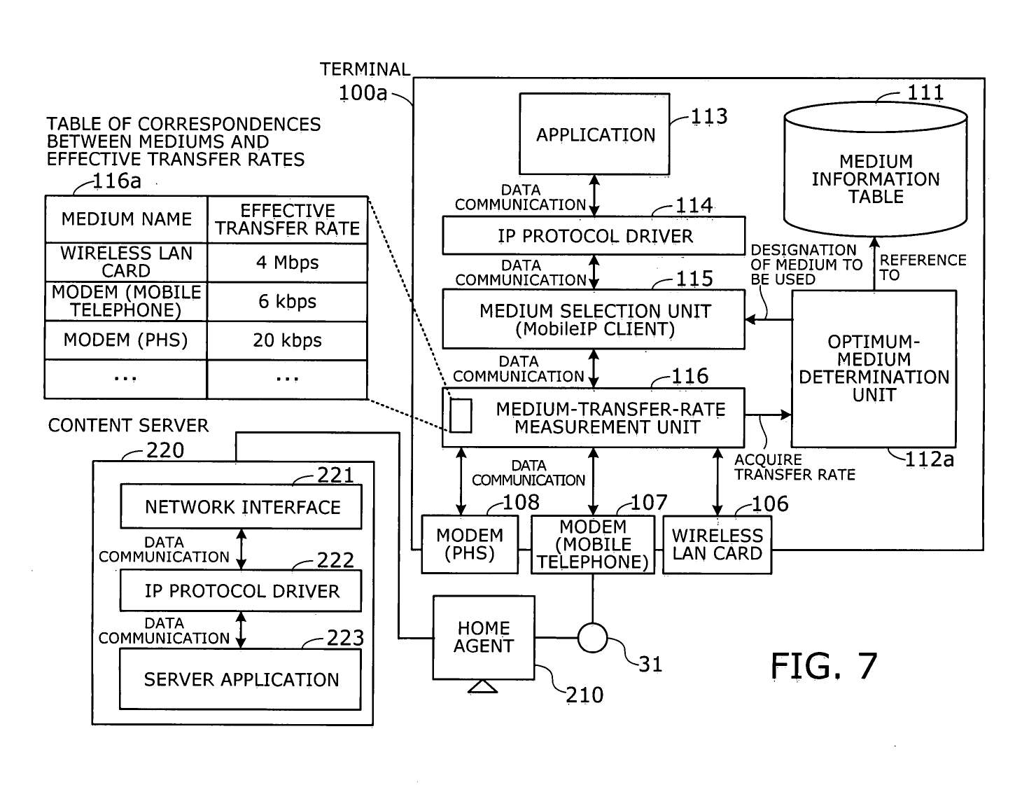

FIG. 7 is a block diagram illustrating functions of a system of the second embodiment of the present invention. In FIG. 7, elements having the same functions as the elements in FIG. 4 bear the same reference numerals as FIG. 4, respectively. A large portion of the construction of the second embodiment illustrated in FIG. 7 is similar to the construction of FIG. 4. Therefore, only the differences from the first embodiment are explained below.

The terminal 100a according to the second embodiment illustrated in FIG. 7 is different from the terminal 100 according to the first embodiment illustrated in FIG. 4 in that a medium-transfer-rate measurement unit 116 is arranged between the network interfaces (i.e., the wireless LAN card 106, the modem 107 for mobile telephone, and the modem 108 for PHS) and the medium selection unit 115. The medium-transfer-rate measurement unit 116 measures an effective transfer rate in data communication through each network interface, and passes measurement results to an optimum-medium determination unit 112a.

In addition, the medium-transfer-rate measurement unit 116 comprises a table 116a of correspondences between mediums and effective transfer rates. In the table 116a, combinations of medium names and effective transfer rates are registered. The medium-transfer-rate measurement unit 116 consecutively records the amount (the number of bytes) of data transferred in every predetermined time interval through each medium, and the greatest value of the recorded amount of data is obtained as the transfer rate, and recorded in the table 116a. When the obtained transfer rate is lower than a predetermined threshold value, the predetermined threshold value is recorded as the effective transfer rate, instead of the obtained transfer rate. In the example of FIG. 7, the effective transfer rate through the wireless LAN card 106 is 4 Mbps, the effective transfer rate through the modem 107 for mobile telephone is 6 Kbps, and the effective transfer rate through the modem 108 for PHS is 20 Kbps.

In the initial state, e.g., immediately after start-up, the optimum-medium determination unit 112a selects an optimum medium by using information (e.g., transmission rates) registered in advance in the medium information table 111, as in the first embodiment.

Thereafter, data communication is performed through the selected medium, and the effective transfer rate in the data communication is measured by the medium-transfer-rate measurement unit 116, and set in the table 116a. In addition, the medium-transfer-rate measurement unit 116 notifies the optimum-medium determination unit 112a of the effective transfer rate.

When the optimum-medium determination unit 112a acquires the effective transfer rate, the optimum-medium determination unit 112a substitutes the transmission rate of the corresponding medium with the acquired effective transfer rate, and performs processing for determining the optimum medium based on the effective transfer rate. When the optimum medium determined based on the newly acquired effective transfer rate is different from the optimum medium which is currently used, the optimum-medium determination unit 112a instructs the medium selection unit 115 to use the newly determined medium as the optimum medium. Then, the medium selection unit 115 switches the medium for use in data communication to the newly determined medium, and the data communication is continued.

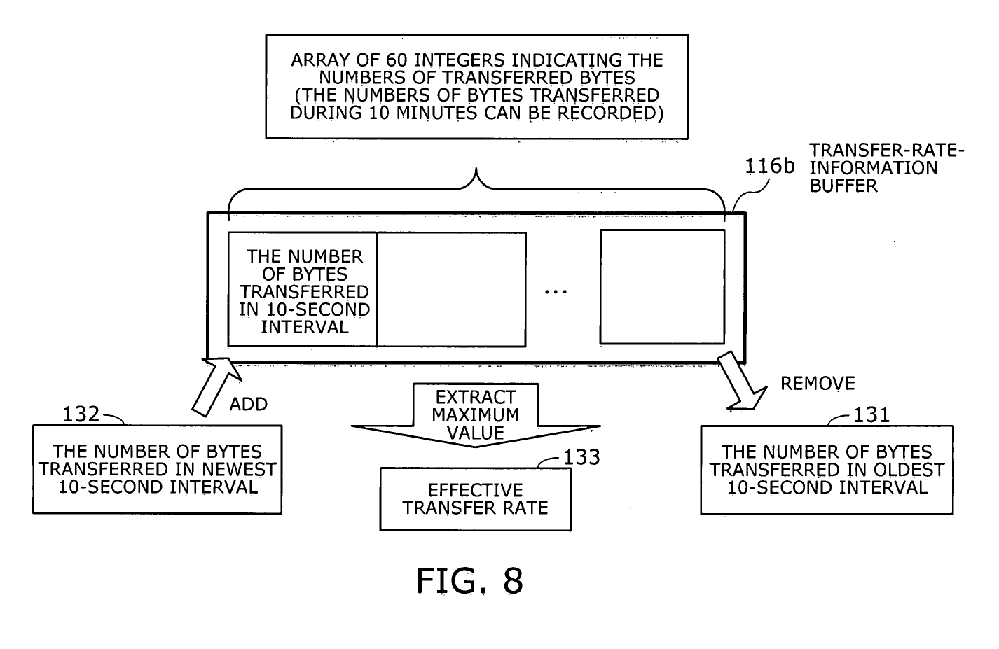

FIG. 8 is a diagram illustrating an example of measurement of the effective transfer rate. In this example, the highest value of data transfer rate measured in every consecutive 10-second interval during the preceding 10 minutes is determined to be the effective transfer rate of the medium.

The medium-transfer-rate measurement unit 116 comprises a transfer-rate-information buffer 116b, in which 60 information items indicating the numbers of bytes of data transferred in the consecutive 10-second intervals are held. That is, the numbers of bytes of data transferred in the consecutive 10-second intervals during the preceding 10 minutes can be recorded in the transfer-rate-information buffer 116b.

During data transfer, the medium-transfer-rate measurement unit 116 measures the number of bytes of data transferred through the used medium in every consecutive 10-second interval, and successively stores in the transfer-rate-information buffer 116b the measured number of bytes of data transferred in every consecutive 10-second interval. When the transfer-rate-information buffer 116b is already filled with an array of 60 integers indicating the numbers of bytes of data transferred in consecutive 10-second intervals, the number of bytes of data in the oldest 10-second interval 131 is removed, and the number of bytes of data in the newest 10-second interval 132 is stored in the transfer-rate-information buffer 116b.

Thereafter, the medium-transfer-rate measurement unit 116 extracts the maximum value of the 60 integers stored in the transfer-rate-information buffer 116b, converts the maximum value (representing the maximum number of bytes of transferred data) into a numerical value representing a transfer rate, and determines the numerical value to be the effective transfer rate 133, where the transfer rate is defined as the number of bits per second (bps).

Thus, in the second embodiment, when the connection-criterion information indicates that the priority criterion is the transmission rate, it is possible to perform data communication while selecting an appropriate medium according to the effective transfer rate.

[Third Embodiment]

The third embodiment is explained below. In the third embodiment, a content server is notified of a data transfer rate (corresponding to a bandwidth) in a used medium, and delivers moving-image data having quality corresponding to the bandwidth.

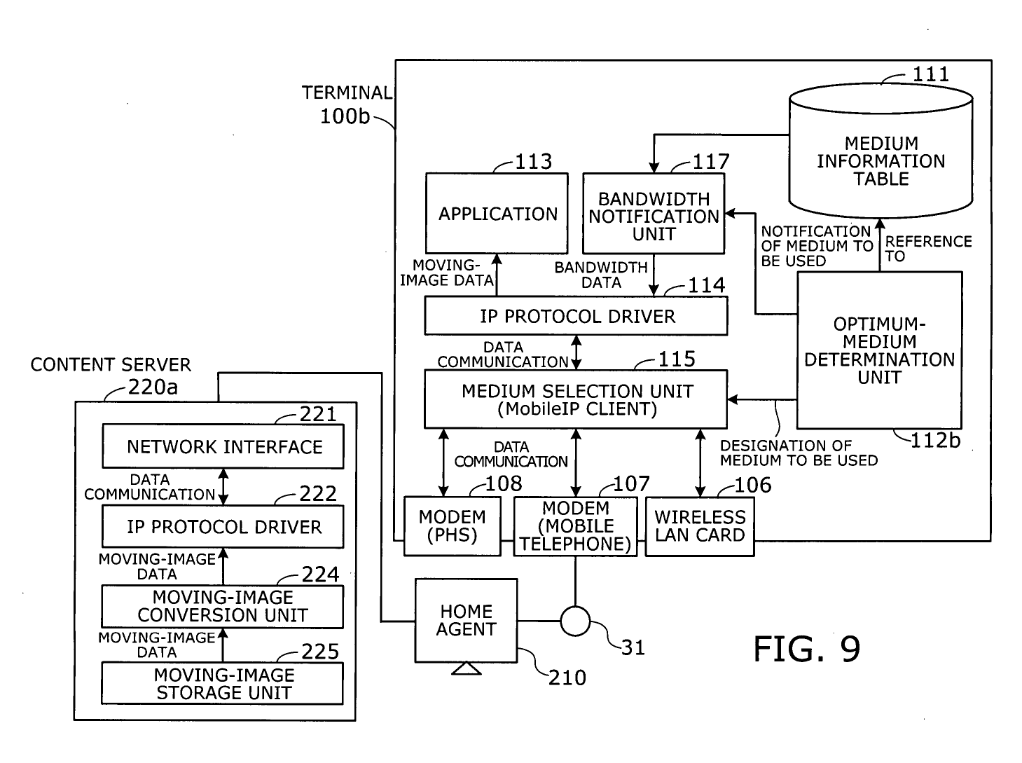

FIG. 9 is a block diagram illustrating functions of a system of the third embodiment of the present invention. In FIG. 9, elements having the same functions as the elements in FIG. 4 bear the same reference numerals as FIG. 4, respectively. A large portion of the construction of the third embodiment illustrated in FIG. 9 is similar to the construction of FIG. 4. Therefore, only the differences from the first embodiment are explained below.

The terminal 100b according to the third embodiment illustrated in FIG. 9 is different from the terminal 100 according to the first embodiment illustrated in FIG. 4 in that a bandwidth notification unit 117 is provided in the terminal 10b. When the bandwidth notification unit 117 is notified by an optimum-medium determination unit 112b of a medium to be used, the bandwidth notification unit 117 refers to the medium information table 111, and acquires the transmission rate (bandwidth) of the medium to be used. Then, the bandwidth notification unit 117 transmits bandwidth data representing the bandwidth through the medium to be used, through the IP protocol driver 114 to the content server 220a with which the terminal 100b currently performs communication.

In addition, the optimum-medium determination unit 112b in the third embodiment has functions similar to the optimum-medium determination unit 112 in the first embodiment (as illustrated in FIG. 4). When the optimum-medium determination unit 112b determines a medium to be used, the optimum-medium determination unit 112b passes to the bandwidth notification unit 117 information (a medium name) indicating the determined medium.

The content server 220a in the third embodiment comprises a moving-image conversion unit 224 and a moving-image storage unit 225 in addition to the elements which the content server 220 in the first embodiment comprises. The moving-image conversion unit 224 performs conversion of moving-image data so that the converted moving-image data has quality corresponding to the bandwidth through the medium connected to the terminal 10b. The moving-image storage unit 225 is a database which stores moving-image data.

The processing which is performed in the above system until the medium to be used is determined is similar to the processing in the first embodiment. When the medium to be used is determined, the following processing is performed.

First, the optimum-medium determination unit 112b passes to the medium selection unit 115 an indication of the medium to be used. In addition, the optimum-medium determination unit 112b notifies the bandwidth notification unit 117 of the name of the medium to be used. Then, the bandwidth notification unit 117 acquires from the medium information table 111 the transmission rate through the medium, and passes to the IP protocol driver 114 bandwidth data representing the transmission rate (or the bandwidth).

The IP protocol driver 114 generates an IP packet containing the bandwidth data, and passes the generated IP packet to the medium selection unit 115, which transmits the IP packet through a network interface corresponding to the selected medium. In the example of FIG. 9, it is assumed that the IP packet is transmitted through the modem 107 for mobile telephone.

The transmitted IP packet is passed through the home agent 210 to the content server 220a. In the content server 220a, the network interface 221 receives the IP packet, and passes the IP packet to the IP protocol driver 222. The IP protocol driver 222 extracts the bandwidth data from the received IP packet, and passes the bandwidth data to the moving-image conversion unit 224, which performs conversion of moving-image data to be delivered to the terminal 100b so that the converted moving-image data has quality corresponding to the received bandwidth data. For example, by the conversion, the quality of the converted moving-image data becomes higher (i.e., the volume of the converted moving-image data becomes greater) when the bandwidth is greater, and the quality of the converted moving-image data becomes lower (i.e., the volume of the converted moving-image data becomes smaller) when the bandwidth is smaller.

Thereafter, as in the first embodiment, when an IP packet containing a request outputted from the application 113 for acquisition of moving-image data is sent to the content server 220a, the IP protocol driver 222 passes the request to the moving-image conversion unit 224. The moving-image conversion unit 224 acquires from the moving-image storage unit 225 the moving-image data designated by the request, and performs conversion of the acquired moving-image data so that the converted moving-image data has quality which is preset in correspondence with the bandwidth. Then, the moving-image conversion unit 224 passes the converted moving-image data to the IP protocol driver 222.

The IP protocol driver 222 inserts the moving-image data in an IP packet, and transmits the IP packet to the terminal 100b in a similar manner to the first embodiment. In the terminal 10b, the moving-image data is passed to the application 113, which reproduces a moving image from the moving-image data.

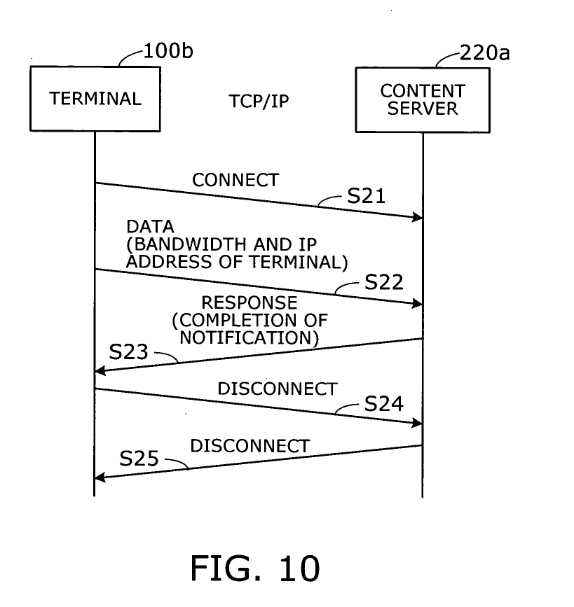

FIG. 10 is a diagram illustrating an example of a protocol for notification of the bandwidth. FIG. 10 shows information exchanged between the terminal 100b and the content server 220a when the terminal 100b notifies the content server 220a of the bandwidth.

First, a connection is established between the terminal 100b and the content server 220a (in step S21). Next, data containing the bandwidth and the IP address of the terminal 100b is sent from the terminal 100b to the content server 220a (in step S22). Then, the content server 220a returns to the terminal 100b a response indicating completion of notification (in step S23). When the terminal 100b receives the response, the terminal 100b sends to the content server 220a a request for disconnection (in step S24). Then, the content server 220a disconnects the connection (in step S25).

As described above, since the content server 220a is notified of the bandwidth, the content server 220a can perform conversion moving-image data so that the converted moving-image data has quality changed according to the bandwidth. For example, the content server 220a can generate the converted moving-image data at an arbitrary quality level by removing a portion of frame images constituting the moving-image data.

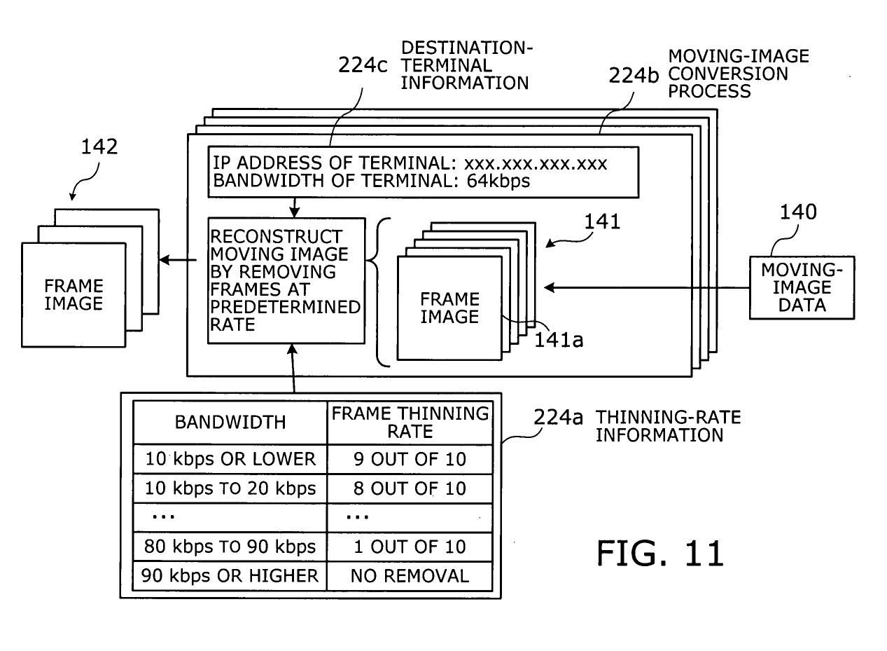

FIG. 11 is a diagram illustrating an example of quality conversion of moving-image data according to the bandwidth. The moving-image conversion unit 224 comprises thinning-rate information 224a, in which frame thinning rates are registered in correspondence with bandwidths. In the example of FIG. 11, the frame thinning rate is nine out of ten when the bandwidth is 10 Kbps or lower, eight out of ten when the bandwidth is in the range from 10 Kbps to 20 Kbps, one out of ten when the bandwidth is in the range from 80 Kbps to 90 Kbps, and zero when the bandwidth is 90 Kbps or higher.

In addition, the moving-image conversion unit 224 generates a moving-image conversion process 224b for each terminal with which the content server 220a performs communication. The moving-image conversion process 224b is a unit of processing for performing conversion of moving-image data to be delivered to each terminal with which the content server 220a performs communication.

When the moving-image conversion unit 224 receives the bandwidth data and the IP address from the terminal 10b, the moving-image conversion unit 224 passes the bandwidth data and the IP address of the terminal 100b as destination-terminal information 224c to a moving-image conversion process 224b corresponding to the terminal 10b. Next, when the moving-image conversion unit 224 receives from the terminal 100b a request for acquisition of moving-image data 140, the moving-image conversion process 224b receives the requested moving-image data 140 from the moving-image storage unit 225. Subsequently, the moving-image conversion process 224b decomposes the moving-image data 140 into frames, and converts the moving-image data 140 into moving-image data 141 constituted by a plurality of frame images 141a.

Thereafter, the moving-image conversion process 224b refers to the thinning-rate information 224a, and determines a frame thinning rate corresponding to the bandwidth through the medium used by the terminal 10b. Next, the moving-image conversion process 224b thins out the moving-image data 141 by removing a portion of frame images from the moving-image data 141, obtains moving-image data 142 which is rearranged to adjust quality, and transmits the rearranged moving-image data 142 to the terminal 10b.

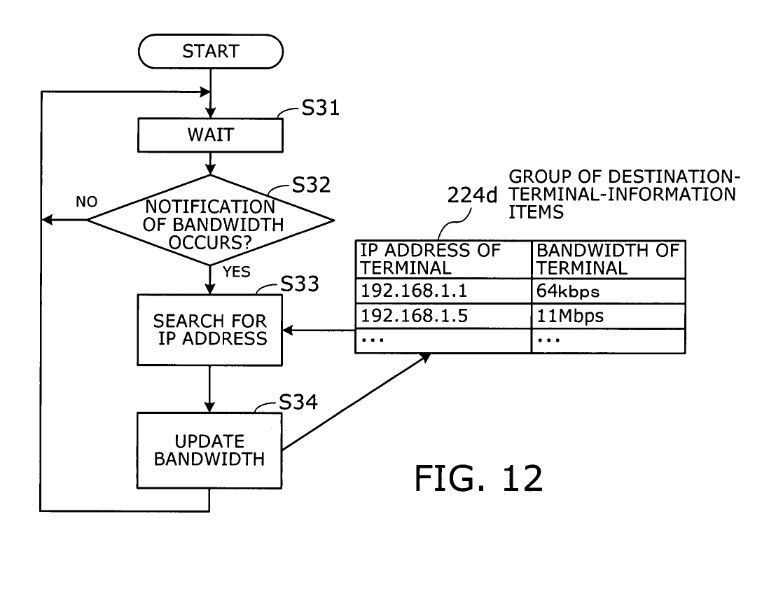

FIG. 12 is a flow diagram illustrating a sequence of processing for registering information on the destination terminal information. In this example, it is assumed that destination-terminal-information items respectively corresponding to a plurality of terminals are managed in a group 224d of destination-terminal information items. The processing illustrated in FIG. 12 is explained below step by step.

[Step S31] The moving-image conversion unit 224 waits for a notification of a bandwidth.

[Step S32] When the moving-image conversion unit 224 is notified of a bandwidth, the operation goes to step S33. When the moving-image conversion unit 224 is not notified of a bandwidth, the moving-image conversion unit 224 continues to wait for a notification of a bandwidth in step S31. Each notification of a bandwidth contains an IP address of a terminal and bandwidth data representing a bandwidth through a medium used by the terminal (e.g., the IP address of the terminal 100b and the bandwidth data representing the bandwidth through the medium used by the terminal 100b).

[Step S33] The moving-image conversion unit 224 searches the group 224d of destination-terminal information items for the IP address contained in the notification.

[Step S34] The moving-image conversion unit 224 updates bandwidth data which has been registered in the group 224d of destination-terminal information items in correspondence with the IP address contained in the notification, with the bandwidth data contained in the notification. Thereafter, the operation goes to step S31, and the moving-image conversion unit 224 waits for a notification of a bandwidth.

As described above, information on the bandwidth corresponding to each terminal can be managed by the content server 220a.

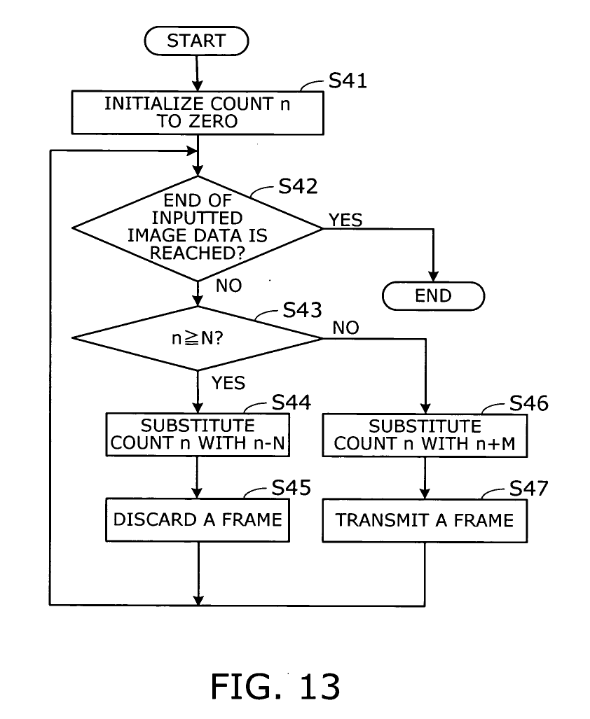

FIG. 13 is a flow diagram illustrating a sequence of processing for conversion of image data. In this example, M frames out of N frames are removed for thinning, where N and M are integers satisfying M<N. The processing illustrated in FIG. 13 is explained below step by step.

[Step S41] The moving-image conversion unit 224 initializes a count n in a counter to zero.

[Step S42] The moving-image conversion unit 224 determines whether or not the end of inputted image data is reached. When yes is determined, the processing of FIG. 13 is completed. When no is determined, the operation goes to step S43.

[Step S43] The moving-image conversion unit 224 determines whether or not the count n is equal to or greater than N (n≧N). When yes is determined, the operation goes to step S44. When no is determined, the operation goes to step S46.

[Step S44] The moving-image conversion unit 224 substitutes the count n with n-N. That is, the moving-image conversion unit 224 subtracts N from the count n, and sets the obtained value as the new value of the count n.

[Step S45] The moving-image conversion unit 224 removes- and discards a frame from the inputted moving-image data. Thereafter, the operation goes to step S42.

[Step S46] The moving-image conversion unit 224 substitutes the count n with n+M. That is the moving-image conversion unit 224 adds M to the count n, and sets the obtained value as the new value of the count n.

[Step S47] The moving-image conversion unit 224 extracts a frame from the inputted moving-image data, and transmits the extracted frame to the terminal 10b. Thereafter, the operation goes to step S42.

As described above, when image data is delivered to a terminal (e.g., the terminal 100b), the image data is converted so that the quality of the converted image data corresponds to the bandwidth through the medium used by the terminal. For example, even when the medium to which the terminal 100b is connected is switched from the wireless LAN to another medium (e.g., the mobile telephone network) during reproduction of a moving image, it is possible to transfer moving-image data having quality appropriate to the bandwidth through the switched medium, without interruption.

In addition, since the moving-image data is converted according to the bandwidth, it is unnecessary to store the moving-image data in a plurality of forms in advance. Therefore, it is possible to save users time and trouble of preparing the moving-image data in a plurality of forms, and reduce necessary memory capacity. Further, even when the moving-image data represents a live image taken by a camera, it is possible to dynamically convert the moving-image data so that the quality of the converted moving image is dynamically changed during delivery.

[Fourth Embodiment]

The fourth embodiment is explained below. In the fourth embodiment, a content server is notified of an effective transfer rate through a medium to be used, and delivers moving-image data having quality corresponding to the effective transfer rate.

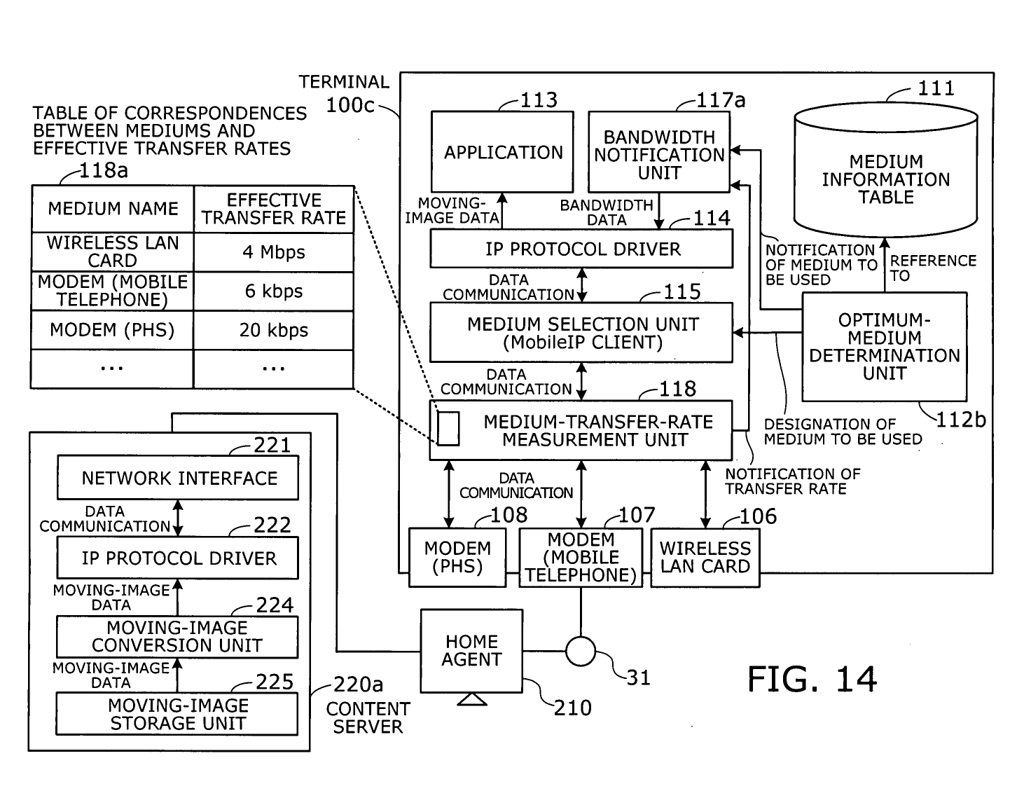

FIG. 14 is a block diagram illustrating functions of a system of the fourth embodiment of the present invention. In FIG. 14, elements having the same functions as the elements in FIG. 9 bear the same reference numerals as FIG. 9, respectively. A large portion of the construction of the fourth embodiment illustrated in FIG. 14 is similar to the construction of FIG. 9. Therefore, only the differences from the third embodiment are explained below.

The terminal 100c according to the fourth embodiment illustrated in FIG. 14 is different from the terminal 100b according to the third embodiment illustrated in FIG. 9 in that a medium-transfer-rate measurement unit 118 is provided in the terminal 100c. The medium-transfer-rate measurement unit 118 has functions which are almost identical to the functions of the medium-transfer-rate measurement unit 116 in the terminal 100a in the second embodiment illustrated in FIG. 7, and comprises a table 118a (of correspondences between mediums and effective transfer rates) having a similar data structure to the table 116a in the medium-transfer-rate measurement unit 116 in the second embodiment. In addition, when the medium-transfer-rate measurement unit 118 in the terminal 100c according to the fourth embodiment measures an effective transfer rate through a selected medium, the medium-transfer-rate measurement unit 118 passes to the bandwidth notification unit 117a information indicating the measured effective transfer rate.

When the bandwidth notification unit 117a is notified by the optimum-medium determination unit 112b of a name of a medium to be used, the bandwidth notification unit 117a acquires from the medium-transfer-rate measurement unit 118 an effective transfer rate corresponding to the name of the medium, converts the acquired effective transfer rate into a bandwidth, and notifies the moving-image conversion unit 224 in the content server 220a of the bandwidth as a bandwidth through the medium which is currently used.

In the system having the above construction, the data transfer rate through the selected medium is measured by the medium-transfer-rate measurement unit 118, and bandwidth data corresponding to the data transfer rate is supplied to the bandwidth notification unit 117a as occasion arises. The bandwidth notification unit 117a transmits the received bandwidth data to the content server 220a through the IP protocol driver 114. Then, an IP packet containing the bandwidth data is transmitted through a currently used network interface (e.g., the modem 107 for mobile telephone in the case of FIG. 14). This IP packet is received at the access point 31, and transferred through the home agent 210 to the content server 220a.

In the content server 220a, the IP packet is received by the network interface 221, and passed to the IP protocol driver 222, The IP protocol driver 222 extracts the bandwidth data corresponding to the data transfer rate from the received IP packet, and passes the bandwidth data to the moving-image conversion unit 224, which determines the quality of the moving-image data according to the bandwidth data corresponding to the data transfer rate. Thereafter, the moving-image conversion unit 224 performs conversion of moving-image data to be delivered to the terminal 100c, and transmits the converted moving-image data to the terminal 100c, where the quality of the converted moving-image data is determined according to the effective transfer rate.

As described above, it is possible to deliver from the content server 220a to the terminal 100c moving-image data having quality corresponding to the effective transfer rate. Therefore, for example, when the communication medium is switched during reproduction of a moving image due to movement of the terminal 100c, or when the effective transfer rate is changed by deterioration of communication quality during communication using an identical communication medium, it is possible to transfer moving-image data having quality corresponding to the effective bandwidth through the medium used in the communication.

[Fifth Embodiment]

The fifth embodiment is explained below. In the fifth embodiment, quality of sound data delivered from a content server is adjusted according to a bandwidth through a medium used by a terminal.

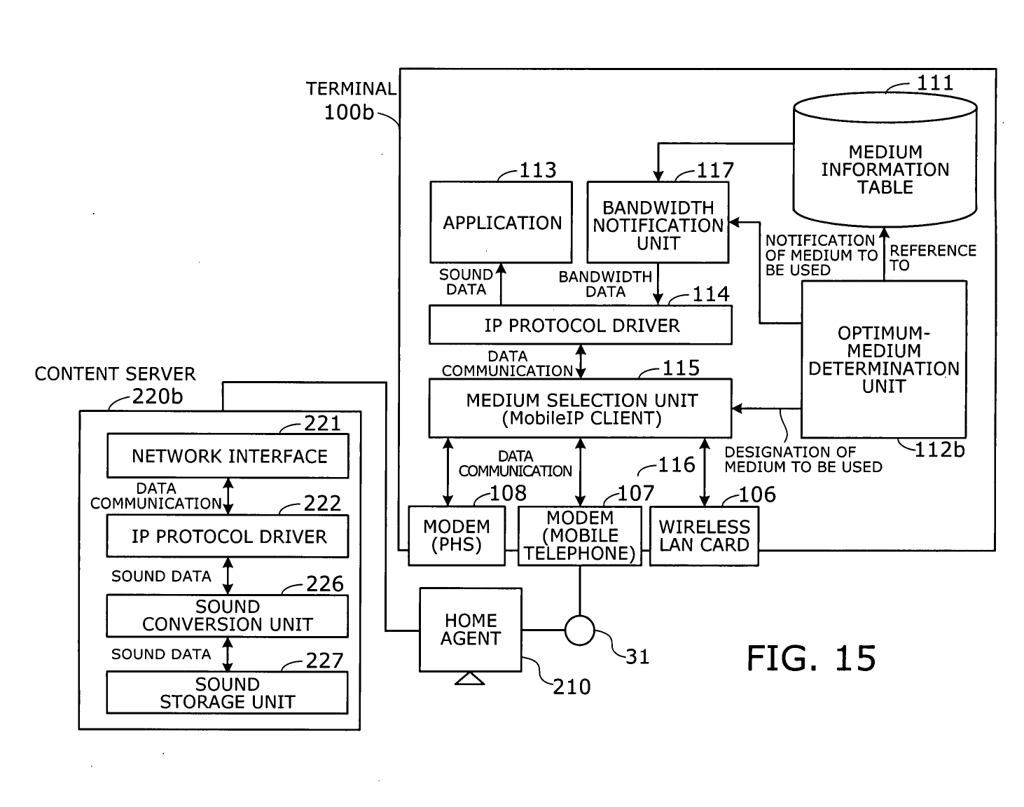

FIG. 15 is a block diagram illustrating functions of a system of the fifth embodiment of the present invention. In FIG. 15, elements having the same functions as the elements in FIG. 9 bear the same reference numerals as FIG. 9, respectively. A large portion of the construction of FIG. 15 is similar to the construction of the third embodiment illustrated in FIG. 9. Therefore, only the differences from the third embodiment are explained below.

The terminal 100b according to the fifth embodiment illustrated in FIG. 15 is similar to the terminal 100b according to the third embodiment illustrated in FIG. 9. However, in the terminal 100b according to the fifth embodiment, users of the terminal 100b can instruct the application 113 to acquire sound data by a manual input operation. The content server 220b according to the fifth embodiment illustrated in FIG. 15 is different from the content server 220a according to the third embodiment illustrated in FIG. 9 in that the content server 220b comprises a sound conversion unit 226 and a sound storage unit 227, instead of the moving-image conversion unit 224 and the moving-image storage unit 225 illustrated in FIG. 9. The sound conversion unit 226 performs conversion of sound data so that the converted sound data has quality corresponding to a bandwidth through a medium to which the terminal 100b is connected. The sound storage unit 227 is a database which stores sound data.

The processing which is performed in the above system from determination of a medium to be used up to transmission of an IP packet containing bandwidth data from the terminal 100b to the content server 220b is similar to the corresponding processing in the third embodiment. When the content server 220b receives the IP packet containing the bandwidth data, the following processing is performed.

In the content server 220b, the network interface 221 receives the IP packet, and passes the received IP packet to the IP protocol driver 222. The IP protocol driver 222 extracts the bandwidth data from the received IP packet, and passes the bandwidth data to the sound conversion unit 226. The sound conversion unit 226 performs conversion of sound data to be delivered to the terminal 100b so that the converted sound data has quality corresponding to the bandwidth data extracted from the received IP packet. For example, by the conversion, the quality (i.e., the volume) of the converted sound data becomes higher when the bandwidth is greater, and lower when the bandwidth is smaller.

Thereafter, as in the third embodiment, when an IP packet containing a request outputted from the application 113 for acquisition of sound data is sent to the content server 220b, the IP protocol driver 222 passes the request to the sound conversion unit 226. The sound conversion unit 226 acquires from the sound storage unit 227 the sound data designated by the request, and performs conversion of the acquired sound data so that the converted sound data has quality which is preset according to the bandwidth. Then, the sound conversion unit 226 passes the converted sound data to the IP protocol driver 222. In the case where the sound data is streaming data, the above conversion is performed from the top of the sound data, and the converted portions of the sound data are successively passed to the IP protocol driver 222.

The IP protocol driver 222 inserts the converted sound data in an IP packet, and transmits the IP packet to the terminal 100b as in the third embodiment. In the terminal 10b, the converted sound data is passed to the application 113, which reproduces sound from the converted sound data.

According to the above processing, for example, even when the medium to which the terminal 100b is connected is switched from the wireless LAN to another medium during reproduction of sound, it is possible to transfer to the application 113 sound data having quality corresponding to the bandwidth through the switched medium, without interruption.

The sound data may be delivered through a network in accordance with VoIP (Voice over IP), which is known as a technique for realizing a voice call through the Internet. An example of application of the present invention to a VoIP system is explained below. In the following example, the fifth embodiment of the present invention is applied to a VoIP system.

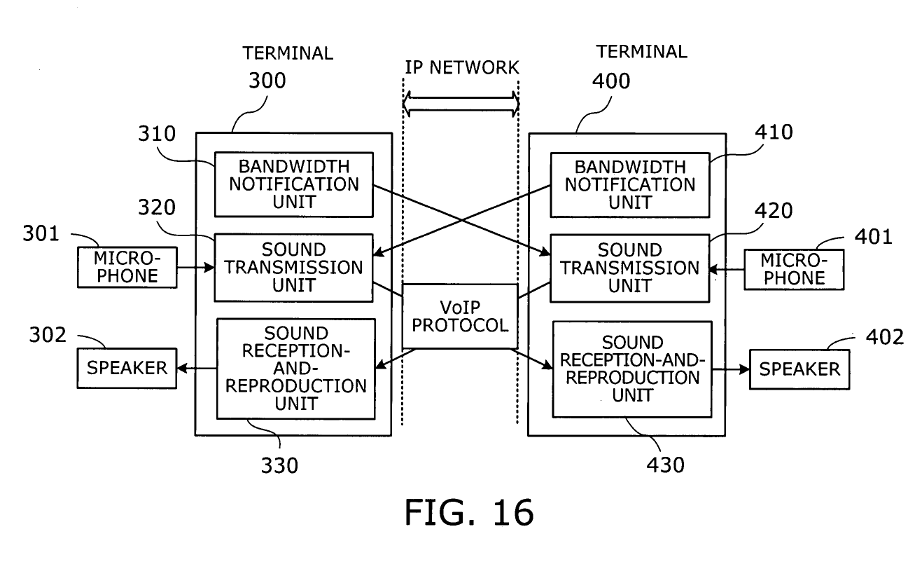

FIG. 16 is a block diagram illustrating functions of a VoIP system in which a dynamic content conversion function is used. In the VoIP system of FIG. 16, communication is performed between two terminals 300 and 400 through an IP network in accordance with VoIP.

The terminal 300 comprises a bandwidth notification unit 310, a sound transmission unit 320, and a sound reception-and-reproduction unit 330. The functions of the bandwidth notification unit 310 include the functions of the medium information table 111, the optimum-medium determination unit 112b, the medium selection unit 115, and the bandwidth notification unit 117 which are illustrated in FIG. 15. In addition, the functions of the sound transmission unit 320 include the functions of the sound conversion unit 226 and the sound storage unit 227 which are illustrated in FIG. 15, and the functions of the sound reception-and-reproduction unit 330 correspond to the functions of the application 113 illustrated in FIG. 15. Further, a microphone 301 is connected to the sound transmission unit 320, and a speaker 302 is connected to the sound reception-and-reproduction unit 330.

Similarly, the terminal 400 comprises a bandwidth notification unit 410, a sound transmission unit 420, and a sound reception-and-reproduction unit 430. A microphone 401 is connected to the sound transmission unit 420, and a speaker 402 is connected to the sound reception-and-reproduction unit 430.

Although not shown for simplification of illustration in FIG. 16, each of the terminals 300 and 400 has the functions necessary for the conventional IP communications, such as an IP protocol driver and a network interface.

In the system having the above construction, bandwidth data representing a bandwidth through a medium used by the terminal 300 is sent from the bandwidth notification unit 310 to the terminal 400. Specifically, the sound transmission unit 420 in the terminal 400 receives the bandwidth data, and determines quality of sound data according to the bandwidth of which the terminal 400 is notified by the terminal 300.

Similarly, bandwidth data representing a bandwidth through a medium used by the terminal 400 is sent from the bandwidth notification unit 410 to the terminal 300. Specifically, the sound transmission unit 320 in the terminal 300 receives the bandwidth data, and determines quality of sound data according to the bandwidth of which the terminal 300 is notified by the terminal 400.

Thereafter, the sound transmission unit 320 performs conversion of sound inputted through the microphone 301 so as to generate sound data having the quality predetermined as above, and transmits the sound data to the terminal 400. In the terminal 400, the sound reception-and-reproduction unit 430 receives the transmitted sound data, and reproduces the sound, which is outputted from the speaker 402.

In addition, the sound transmission unit 420 performs conversion of sound inputted through the microphone 401 so as to generate sound data having the quality predetermined as above, and transmits the sound data to the terminal 300. In the terminal 300, the sound reception-and-reproduction unit 330 receives the transmitted sound data, and reproduces the sound, which is outputted from the speaker 302.

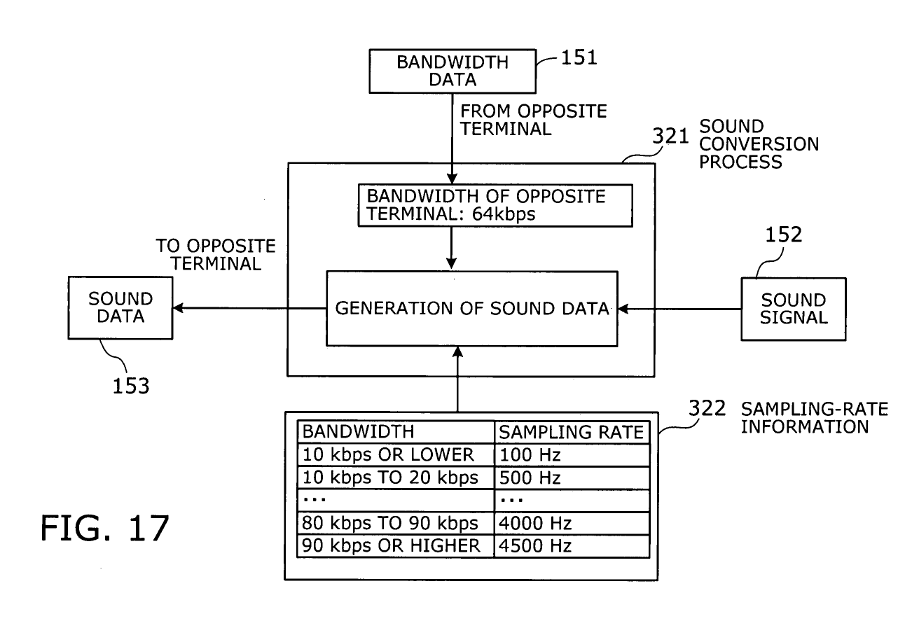

FIG. 17 is a diagram illustrating the sound conversion function in the sound transmission unit 320. The sound transmission unit 320 comprises a sound conversion process 321 and sampling-rate information 322. The sound conversion process 321 converts a sound signal 152 inputted from the microphone 301 into sound data 153. The sampling-rate information 322 is a database in which sampling rates are registered according to bandwidths in the opposite terminal. In the example of FIG. 17, the sampling rate is 100 Hz when the bandwidth is 10 Kbps or lower, 500 Hz when the bandwidth is in the range from 10 Kbps to 20 Kbps, 4,000 Hz when the bandwidth is in the range from 80 Kbps to 90 Kbps, and 4,500 Hz when the bandwidth is equal to or higher than 90 Kbps.

In the example of FIG. 17, when the bandwidth data 151 is transmitted from the opposite terminal 400, the sound conversion process 321 holds the bandwidth data 151. In addition, when the sound signal 152 is inputted from the microphone 301, the sound conversion process 321 refers to the sampling-rate information 322, and determines a sampling rate corresponding to the bandwidth of the opposite terminal 400. Next, the sound conversion process 321 generates sound data 153 by thinning out waveform data which is obtained from the sound signal 152, based on the determined sampling rate. In addition, the sound conversion process 321 transmits to the terminal 400 the sound data 153 generated as above.

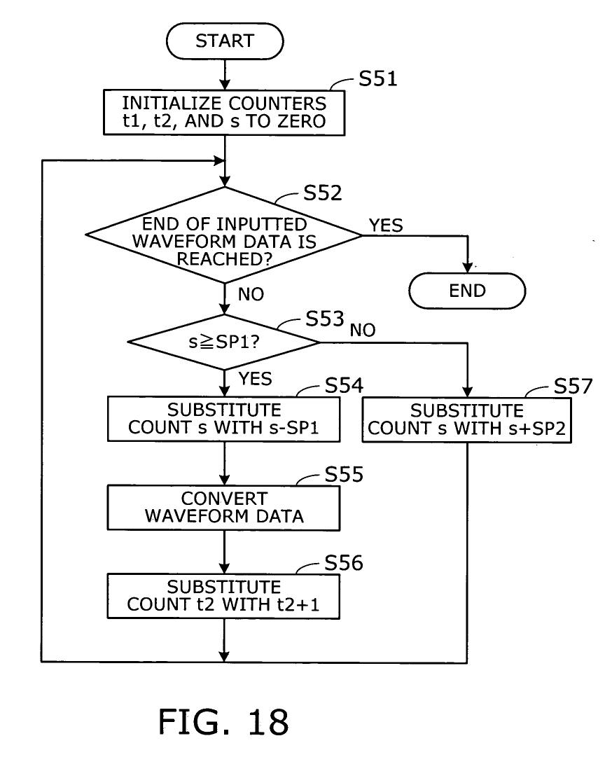

FIG. 18 is a flow diagram illustrating a sequence of processing for generating sound data. In the example of FIG. 18, it is assumed that sound waveform data sampled at a sampling rate SP2 (Hz) is obtained from sound waveform data sampled at a sampling rate SP1 (Hz), where SP2≧SP1. The processing illustrated in FIG. 18 is explained below step by step.

[Step S51] The sound transmission unit 320 initializes counts t1, t2, and s in counters to zero.

[Step S52] The sound transmission unit 320 determines whether or not the end of the input waveform data is reached. When yes is determined, the processing of FIG. 18 is completed. When no is determined, the operation goes to step S53.

[Step S53] The sound transmission unit 320 determines whether or not the count s is equal to or greater than SP1 (s≧SP1). When yes is determined, the operation goes to step S54. When no is determined, the operation goes to step S57.

[Step S54] The sound transmission unit 320 substitutes the count s with s-SP1. That is, the sound transmission unit 320 subtracts SP1 from the count s, and sets the obtained value s-SP1 as the new value of the count s.

[Step S55] The sound transmission unit 320 performs conversion of waveform data. Specifically, the sound transmission unit 320 sets a value of the input waveform data corresponding to the count t1 as a value of the output waveform data corresponding to the count t2.

[Step S56] The sound transmission unit 320 substitutes the count t2 with t2+1. That is, the sound transmission unit 320 adds one to (increments) the count t2, and sets the incremented value t2+1 as the new value of the count t2.

[Step S57] The sound transmission unit 320 substitutes the count s with s+SP2. That is, the sound transmission unit 320 adds SP2 to the count s, and sets the obtained value s+SP2 as the new value of the count s. Thereafter, the operation goes to step S52.

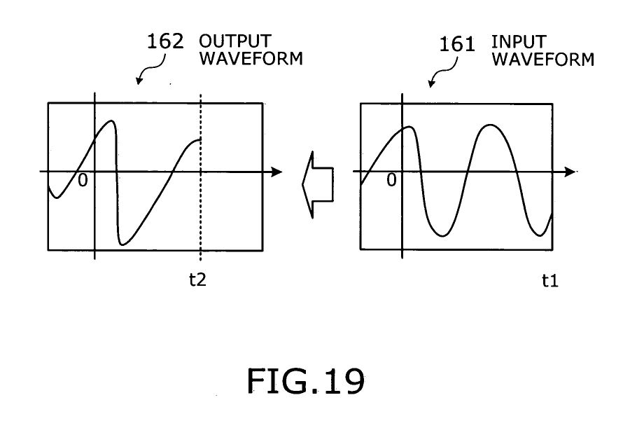

FIG. 19 is a diagram illustrating an example of conversion of waveform data. In FIG. 19, an input waveform 161 and a corresponding output waveform 162 are shown, where the abscissas correspond to progression of time, and the ordinates correspond to the amplitudes.

In the conversion of the waveform data, only a portion of the input waveform 161 up to time t2 is cut out of the entire input waveform 161 which has been inputted until time t1, and becomes the output waveform 162.

As described above, communications in accordance with VoIP can be stably performed by transmitting sound data having quality corresponding to a bandwidth of an opposite party.

Although, in the above example, the quality of sound data is determined based on only the bandwidth through the medium to which the terminal at the opposite end is connected, alternatively, it is possible to determine the quality of sound data in consideration of both of bandwidths of mediums to which the opposite terminals are respectively connected. For example, it is possible to determine the quality of the sound data based on a smaller one of the bandwidths of the mediums to which the opposite terminals are respectively connected.

[Sixth Embodiment]

The sixth embodiment is explained below. In the sixth embodiment, quality of sound data is adjusted based on an effective transfer rate through a medium to be used.

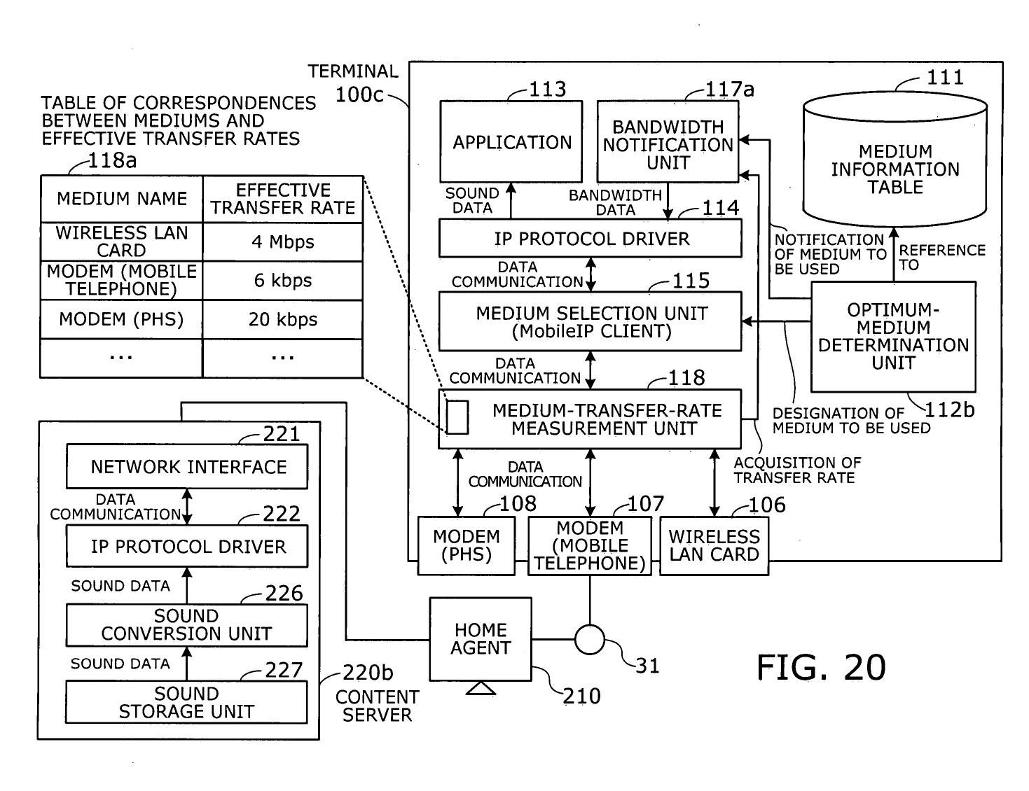

FIG. 20 is a block diagram illustrating functions of a system of the sixth embodiment of the present invention. The terminal 100c according to the sixth embodiment illustrated in FIG. 20 has a construction similar to the construction of the terminal 100c according to the fourth embodiment illustrated in FIG. 14, except that the application 113 outputs a request for data acquisition in which sound data is designated. In addition, the content server 220b according to the sixth embodiment illustrated in FIG. 20 has a construction similar to the construction of the content server 220b according to the fifth embodiment illustrated in FIG. 15. In FIG. 20, the terminal 100c and the content server 220b are connected through the access point 31 and the home agent 210. In FIG. 20, elements having the same functions as the elements in FIG. 14 or 15 bear the same reference numerals as FIG. 14 or 15, respectively.

In the above system, the optimum-medium determination unit 112b determines one of the wireless LAN card 106, the modem 107 for mobile telephone, and the modem 108 for PHS to be a medium for use, based on information registered in the medium information table 111, and notifies the medium selection unit 115 of the determined medium. In the following explanations, it is assumed that the modem 107 for mobile telephone is used.

In addition, the optimum-medium determination unit 112b notifies the bandwidth notification unit 117a of the name of the determined medium. Then, the medium-transfer-rate measurement unit 118 passes to the bandwidth notification unit 117a an effective transfer rate of the medium to be used, and the bandwidth notification unit 117a passes to the IP protocol driver 114 bandwidth data corresponding to the effective transfer rate. Then, the IP protocol driver 114 transmits to the content server 220b an IP packet containing the bandwidth data.

The IP packet is transmitted through the modem 107 for mobile telephone to the access point 31, and passed through the home agent 210 to the content server 220b. In the content server 220b, the network interface 221 receives the IP packet, and passes the IP packet to the IP protocol driver 222. The IP protocol driver 222 extracts the bandwidth data from the received IP packet, and passes the extracted bandwidth data to the sound conversion unit 226, which determines the quality of sound data to be delivered, according to the bandwidth data indicating the effective transfer rate.

Thereafter, when the application 113 outputs a request for acquisition of sound data from the content server 220b, the request is transmitted to the content server 220b, and the sound data is acquired from the sound storage unit 227. The sound conversion unit 226 performs conversion of the sound data so that the converted sound data has quality corresponding to the effective transfer rate through the medium used by the terminal 100c. Then, the converted sound data is passed to the IP protocol driver 222. The IP protocol driver 222 generates an IP packet containing the converted sound data, and transmits the IP packet to the terminal 100c.

The transmitted IP packet containing the converted sound data is transferred through the home agent 210 and the access point 31 to the terminal 100c. In the terminal 100c, the IP packet is received by the modem 107 for mobile telephone, and passed to the IP protocol driver 114 and the like. Then, the converted sound data is extracted from the IP packet by the IP protocol driver 114 and the like, and passed to the application 113, which reproduces sound from the converted sound data.

According to the above system, for example, even when the medium to which the terminal 100c is connected is switched from the wireless LAN to another medium during reproduction of sound, it is possible to perform conversion of sound data to be transferred to the application 113 so that the converted sound data has quality corresponding to the bandwidth through the switched medium, and transfer the converted sound data to the application 113 without interruption.

[Seventh Embodiment]

The seventh embodiment is explained below. In the seventh embodiment, sound data is converted into character data when a bandwidth is below a predetermined value.

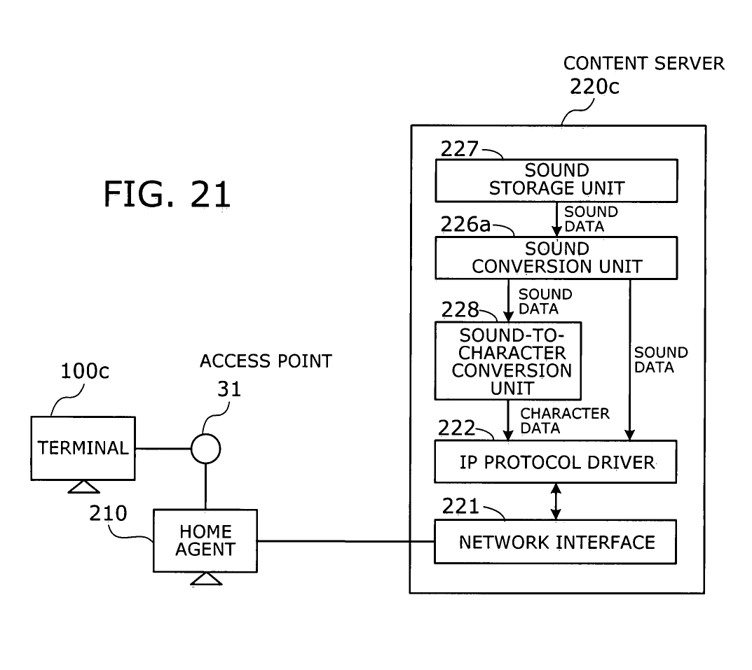

FIG. 21 is a block diagram illustrating functions of a system of the seventh embodiment of the present invention. In FIG. 21, elements having the same functions as the elements in FIG. 20 bear the same reference numerals as FIG. 20, respectively. A large portion of the construction of the seventh embodiment illustrated in FIG. 21 is similar to the construction of the sixth embodiment illustrated in FIG. 20. Therefore, only the differences from the sixth embodiment are explained below.

The content server 220c according to the seventh embodiment illustrated in FIG. 21 is different from the content server 220b according to the sixth embodiment illustrated in FIG. 20 in that a sound-to-character conversion unit 228 is arranged between a sound conversion unit 226a and an IP protocol driver 222.

When the sound-to-character conversion unit 228 receives sound data from the sound conversion unit 226a, the sound-to-character conversion unit 228 converts the sound data into character data, which is constituted by a plurality of character codes. The sound-to-character conversion unit 228 passes the character data to the IP protocol driver 222.

In the sound conversion unit 226a, a threshold value of a bandwidth is preset for use in determination whether or not sound data is to be converted into character data. When the sound conversion unit 226a receives the bandwidth data transmitted from the terminal 100c, the sound conversion unit 226a compares the bandwidth data with the threshold value. When a value represented by the bandwidth data exceeds the threshold value, the sound conversion unit 226a determines the quality of the sound data in accordance with the bandwidth data. On the other hand, when the value represented by the bandwidth data does not exceed the threshold value, the sound conversion unit 226a determines that the sound data is to be converted into character data. After the determination to be converted into character data, the sound conversion unit 226a passes to the sound-to-character conversion unit 228 the sound data to be transmitted to the terminal 100c.

In the above system, when the terminal 100c outputs an IP packet containing bandwidth data, the IP packet is transferred through the access point 31 and the home agent 210 to the content server 220c. In the content server 220c, the network interface 221 receives the IP packet, and passes the IP packet to the IP protocol driver 222. The IP protocol driver 222 extracts the bandwidth data from the IP packet, and passes the extracted bandwidth data to the sound conversion unit 226a.

When the sound conversion unit 226a receives the bandwidth data for the medium used by the terminal 100c, the sound conversion unit 226a performs conversion of sound data stored in the sound storage unit 227 so that the converted sound data can be transmitted with the bandwidth of the terminal 100c. At this time, the value represented by the received bandwidth data is below the threshold value, the sound data acquired from the sound storage unit 227 is passed to the sound-to-character conversion unit 228 without changing the acquired sound data. Then, the sound-to-character conversion unit 228 converts the sound data into character data, and transmits the character data to the terminal 100c.

As described above, when sound data cannot be stably transmitted due to deterioration of communication quality, the sound data is converted into character data for transmission. Therefore, even when the terminal 100c moves to a place in which communication conditions are poor, it is possible to acquire information of a predetermined type without interruption. For example, in the case where a user checks a news flash on the terminal 100c, the user can hear voice reading the news flash when the terminal 100c can receive sound data, or read the news indicated by characters when the reception conditions are poor.

[Eighth Embodiment]

The eighth embodiment is explained below. In the eighth embodiment, data representing a map image is processed so that the processed data has quality corresponding to a bandwidth through a medium used by a terminal.

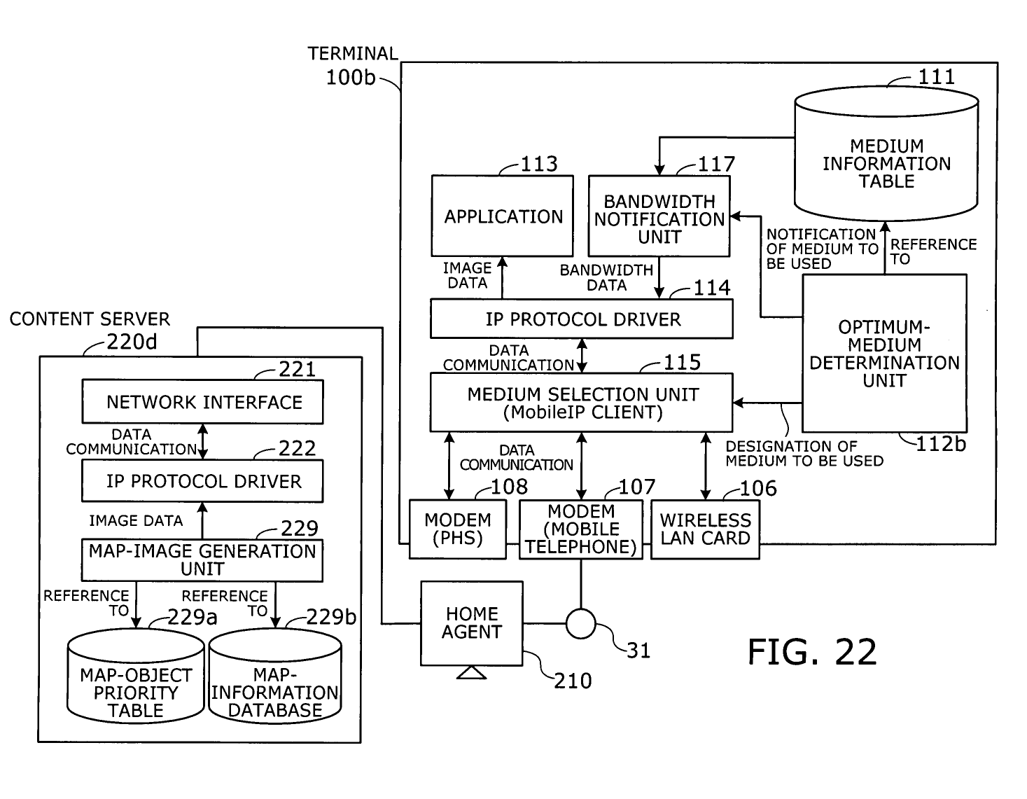

FIG. 22 is a block diagram illustrating functions of a system of the eighth embodiment of the present invention. In FIG. 22, elements having the same functions as the elements in FIG. 9 bear the same reference numerals as FIG. 9, respectively. A large portion of the construction of the eighth embodiment illustrated in FIG. 22 is similar to the construction of FIG. 9. Therefore, only the differences from the third embodiment are explained below.

The terminal 100b according to the eighth embodiment is different from the terminal 100b according to the third embodiment in that the application 113 outputs a request for acquisition of data, where a map image is designated in the request. In addition, the content server 220d according to the eighth embodiment comprises a map-image generation unit 229, a map-object priority table 229a, and a map-information database 229b in addition to the elements in the content server 220a illustrated in FIG. 9. When the map-image generation unit 229 receives bandwidth data, the map-image generation unit 229 refers to the map-object priority table 229a, and determines types of objects to be included in the map information which is transmitted to the terminal 100c. The types of objects may be “ROAD,” “BUILDING,” “PLACE NAME,” or the like. Further, it is possible to classify buildings into public buildings and private buildings.

In response to a request for acquisition of a map image, which is received from the terminal 100b, the map-image generation unit 229 acquires map information from the map-information database 229b, and generates the map image. At this time, the map information acquired from the map-information database 229b includes only objects which are determined to be transmitted based on a bandwidth through a medium used by the terminal 100b. The map-image generation unit 229 delivers the generated map image to the terminal 100b.

The map-object priority table 229a is a database in which priorities of respective types of objects are set. Objects of types having priorities represented by greater numerical values are determined to be transferred even when the bandwidth is smaller.

The map-information database 229b is a database in which objects constituting each map are registered. In each of the registered objects, the type of the object and information on the position of the object on the map are set.

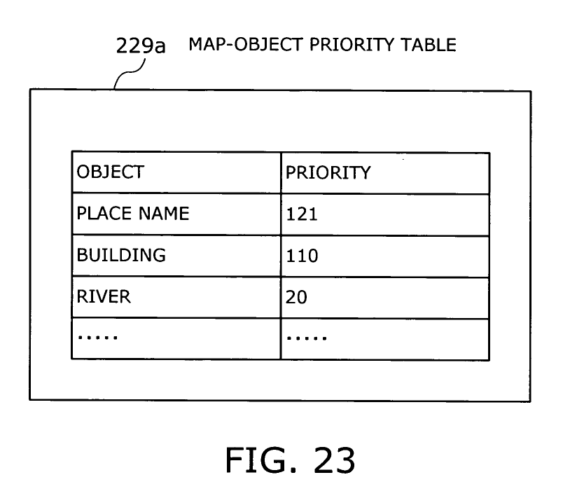

FIG. 23 is a diagram illustrating an example of a data structure of the map-object priority table. The map-object priority table 229a has fields of “OBJECT” and “PRIORITY,” and information items arranged in each row of the map-object priority table 229a are related to each other.

In the field of “OBJECT,” the type of each object is set. In the example of FIG. 23, the types “PLACE NAME,” “BUILDING,” “RIVER,” and the like are set.

In the field of “PRIORITY,” the priority of each type of objects is set. In the example of FIG. 23, the priority of the type “PLACE NAME” is “121,” the priority of the type “BUILDING” is “110,” and the priority of the type “RIVER” is “20.”

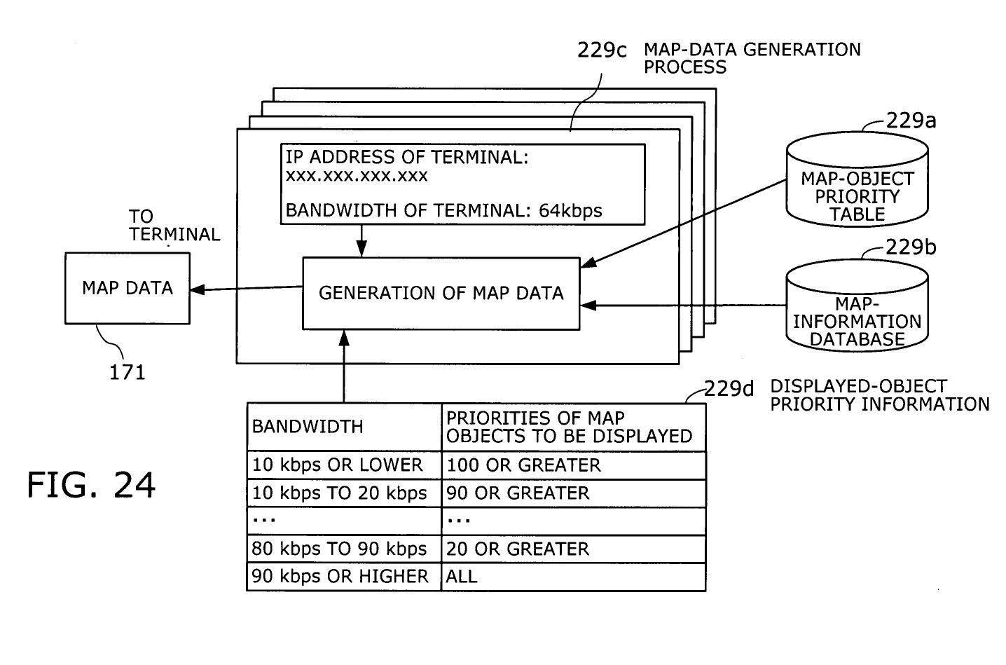

FIG. 24 is a diagram illustrating an example of generation of map data which has quality corresponding to a bandwidth. The map-image generation unit 229 comprises displayed-object priority information 229d, in which bandwidths and corresponding priorities of map objects to be displayed are registered. In the example of FIG. 24, map objects having priorities of 100 or greater can be determined to be displayed when the bandwidth is 10 Kbps or lower, map objects having priorities of 90 or greater can be determined to be displayed when the bandwidth is in the range from 10 Kbps to 20 Kbps, map objects having priorities of 20 or greater can be determined to be displayed when the bandwidth is in the range from 80 Kbps to 90 Kbps, and all of the map objects can be determined to be displayed when the bandwidth is equal to or higher than 90 Kbps.

In addition, in the map-image generation unit 229, a map-data generation process 229c is generated for each terminal opposite to the content server 220d. The map-data generation process 229c is a unit of processing for performing conversion of map data to be delivered to a corresponding terminal so as to change the quality of the map data.

When the map-image generation unit 229 receives bandwidth data and an IP address transmitted from the terminal 10b, the map-image generation unit 229 passes to the map-data generation process 229c the bandwidth data and the IP address of the terminal 100b as destination-terminal information. Thereafter, when the map-image generation unit 229 receives from the terminal 100b a request for acquisition of map data, the map-data generation process 229c refers to the displayed-object priority information 229d, and determines one or more priorities of map objects which can be displayed, based on the bandwidth of the terminal 10b.

Next, the map-data generation process 229c refers to the map-object priority table 229a, and determines the one or more types of objects corresponding to the one or more priorities of map objects which can be displayed. Then, the map-data generation process 229c extracts map objects included in the area of the requested map from map objects which are stored in the map-information database 229b and belong to the one or more types determined as above. Then, the map-data generation process 229c generates map data 171 from the extracted map objects, and transmits the generated map data 171 to the terminal 10b.

The sequence of the processing for registering destination-terminal information performed by the map-image generation unit 229 is similar to the sequence of the processing for registering destination-terminal information performed by the moving-image conversion unit 224 illustrated in FIG. 12.

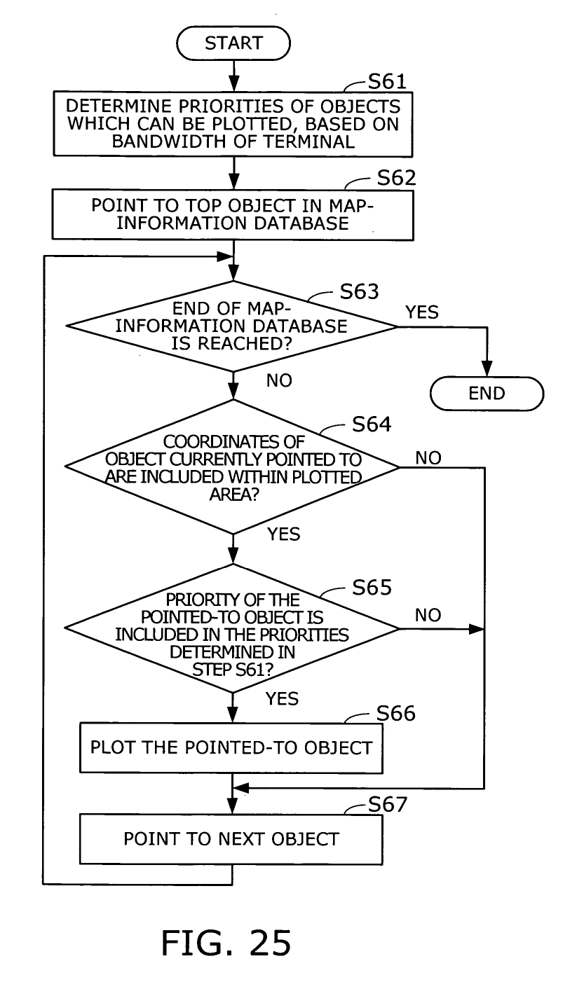

FIG. 25 is a flow diagram illustrating a sequence of processing for generating map data. The processing illustrated in FIG. 25 is explained below step by step.

[Step S61] The map-data generation process 229c refers to the displayed-object priority information 229d, and determines one or more priorities of map objects which can be plotted, based on the bandwidth of the terminal

[Step S62] The map-data generation process 229c points to an object which is stored at the top address in the map-information database 229b.

[Step S63] The map-data generation process 229c determines whether or not the end of the map-information database 229b is reached. When yes is determined, the processing of FIG. 25 is completed. When no is determined, the operation goes to step S64.

[Step S64] The map-data generation process 229c determines whether or not the coordinates of the object which is currently pointed to are included within the area in which the map is to be plotted. When yes is determined, the operation goes to step S65. When no is determined, the operation goes to step S67.

[Step S65] The map-data generation process 229c determines whether or not the priority assigned to the type of the object which is currently pointed to is included in the one or more priorities determined in step S61. When yes is determined, the operation goes to step S66. When no is determined, the operation goes to step S67.

[Step S66] The map-data generation process 229c plots the object which is currently pointed to. Alternatively, the map-data generation process 229c may not actually plot the object, and may instead add the object which is currently pointed to, as an object to be plotted, to map data having a predetermined form. In this case, the application 113 interprets the object based on the map data, and plots the object.

[Step S67] The map-data generation process 229c points to the next object. Thereafter, the operation goes to step S63.

As described above, it is possible to generate map data having quality corresponding to the bandwidth through the medium used by the terminal 10b, and deliver the map data to the terminal 10b.

[Ninth Embodiment]

The ninth embodiment is explained below. In the ninth embodiment, map data having quality corresponding to an effective transfer rate of a medium used by a terminal is transmitted.

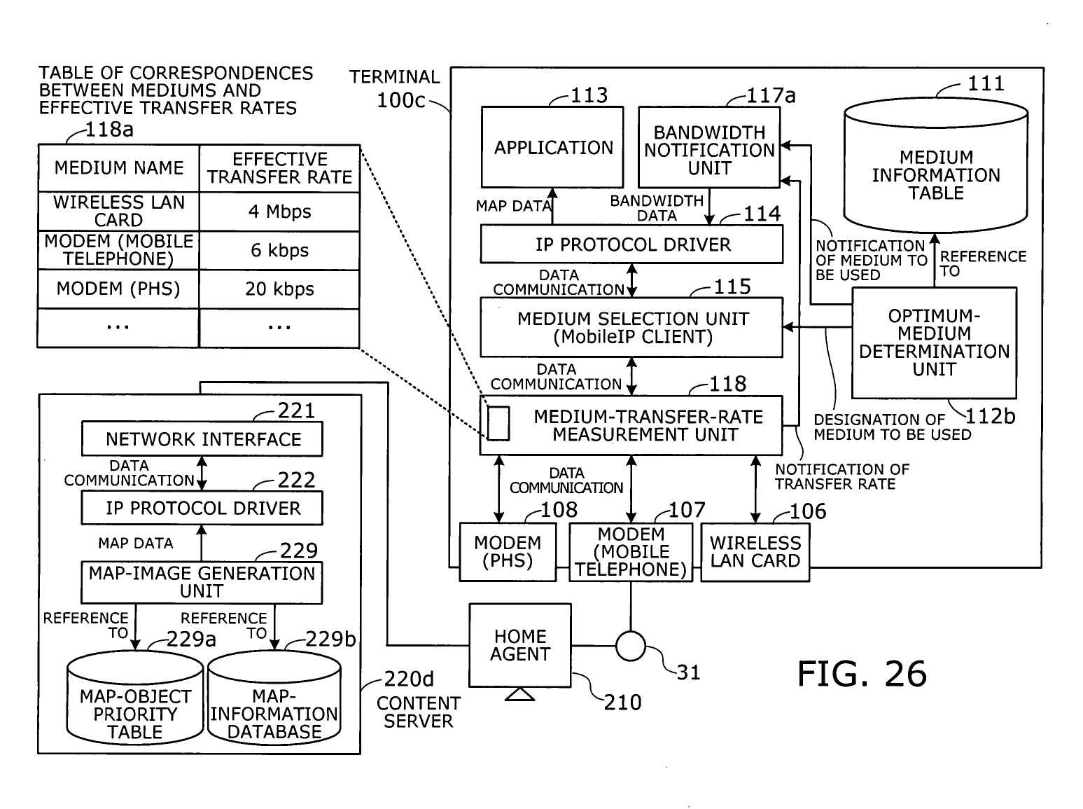

FIG. 26 is a block diagram illustrating functions of a system of the ninth embodiment of the present invention. The terminal 100c according to the ninth embodiment illustrated in FIG. 26 has a construction similar to the construction of the terminal 100c according to the fourth embodiment illustrated in FIG. 14, except that the application 113 outputs a request for acquisition of data, where map data is designated in the request. In addition, the content server 220d according to the ninth embodiment illustrated in FIG. 26 has a construction similar to the content server 220d according to the eighth embodiment illustrated in FIG. 22. In FIG. 26, the terminal 100c and the content server 220d are connected through the access point 31 and the home agent 210. In FIG. 26, elements having the same functions as the elements in FIG. 14 or 22 bear the same reference numerals as FIG. 14 or 22, respectively.

In the above system, the optimum-medium determination unit 112b determines one of the wireless LAN card 106, the modem 107 for mobile telephone, and the modem 108 for PHS to be a medium for use, based on information registered in the medium information table 111, and notifies the medium selection unit 115 of the determined medium. In the following explanations, it is assumed that the modem 107 for mobile telephone is used.

In addition, the optimum-medium determination unit 112b notifies the bandwidth notification unit 117a of the name of the determined medium. Then, the medium-transfer-rate measurement unit 118 passes to the bandwidth notification unit 117a an effective transfer rate of the medium to be used, and the bandwidth notification unit 117a passes to the IP protocol driver 114 bandwidth data corresponding to the effective transfer rate. Then, the IP protocol driver 114 transmits to the content server 220d an IP packet containing the bandwidth data.

The IP packet is transmitted through the modem 107 for mobile telephone to the access point 31, and passed through the home agent 210 to the content server 220d. In the content server 220d, the network interface 221 receives the IP packet, and passes the IP packet to the IP protocol driver 222. The IP protocol driver 222 extracts the bandwidth data from the received IP packet, and passes the extracted bandwidth data to the map-image generation unit 229, which determines the quality of map data to be delivered, according to the bandwidth data indicating the effective transfer rate. That is, at least one priority of map objects to be included in the map data is determined.

Thereafter, when the application 113 outputs a request for acquisition of sound data from the content server 220d, the request is transmitted to the content server 220d, and map objects to be displayed is acquired from the map-information database 229b. The map-image generation unit 229 generates map data having quality corresponding to the effective transfer rate of the medium used by the terminal 100c, based on the map objects acquired from the map-information database 229b, and passes the generated map data to the IP protocol driver 222. The IP protocol driver 222 generates an IP packet containing the map data, and transmits the IP packet to the terminal 100c.

The transmitted IP packet containing the map data is transferred through the home agent 210 and the access point 31 to the terminal 100c. In the terminal 100c, the IP packet is received by the modem 107 for mobile telephone, and passed to the IP protocol driver 114 and the like. Then, the map data is extracted from the IP packet by the IP protocol driver 114 and the like, and passed to the application 113, which displays a map image based on the map data.

According to the above system, for example, even when the medium to which the terminal 100c is connected is switched from the wireless LAN to another medium during the operation of displaying a map, it is possible to transfer to the application 113 map data having quality corresponding to the bandwidth through the switched medium, without interruption.

[Tenth Embodiment]

The tenth embodiment is explained below. In the tenth embodiment, the present invention is applied to a live delivery system. When the present invention is applied to the live delivery system, it is possible to deliver a live image with quality corresponding to a communication environment of each of a plurality of users. That is, real-time delivery of a moving image with multiple bit rates is enabled.

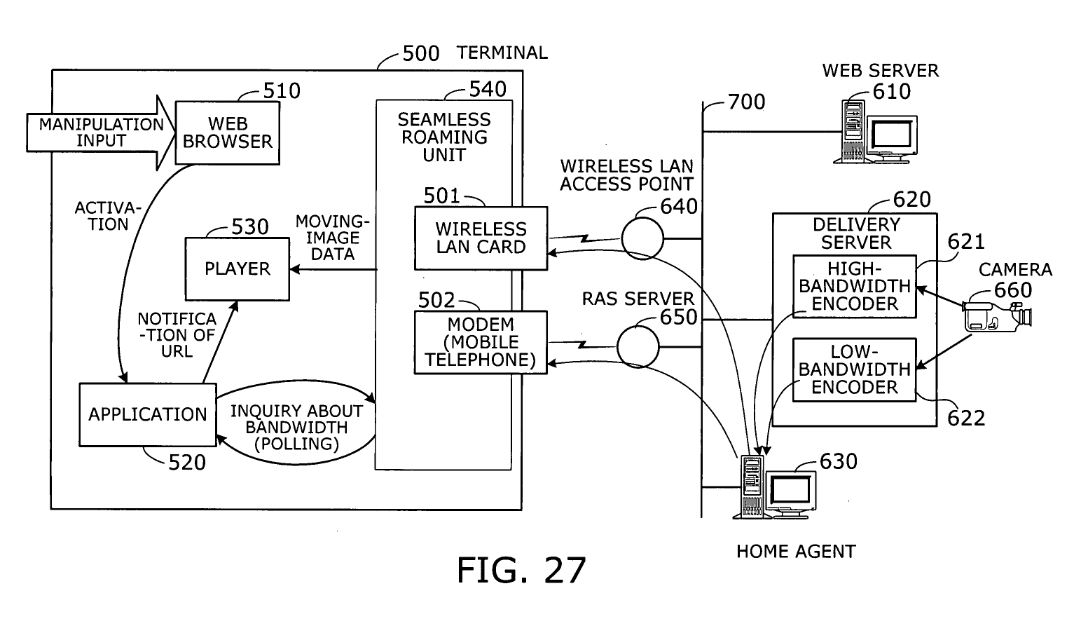

FIG. 27 is a block diagram illustrating functions of a system of the tenth embodiment of the present invention. In the system of FIG. 27, a terminal 500 comprises a wireless LAN card 501 and a modem 502 for mobile telephone. The wireless LAN card 501 can be connected to a network 700 through a wireless-LAN access point 640, and the modem 502 for mobile telephone can be connected to the network 700 through an RAS (remote access server) server 650. A web server 610, a delivery server 620, a home agent 630, the wireless-LAN access point 640, and the RAS server 650 are connected to the network 700.

The terminal 500 comprises a web browser 510, an application 520, a player 530, and a seamless roaming unit 540. In response to a manipulation input by a user, the web browser 510 acquires web content through the network, and displays the web content. When a manipulation input for requesting acquisition of a moving image which can be delivered live occurs, the web browser 510 activates the application 520.

The application 520 monitors variations in the bandwidth. Specifically, the application 520 periodically polls the seamless roaming unit 540 for inquiring about the bandwidth, and acquires bandwidth data representing the bandwidth through the currently used network. When the bandwidth is changed, the application 520 notifies the player 530 of a URL (uniform resource locator) of an encoder corresponding to the changed bandwidth. That is, the application 520 performs processing for determining quality of content according to the bandwidth.

The player 530 downloads through the seamless roaming unit 540 moving-image data corresponding to the URL of which the player 530 is notified, and displays a moving image based on the moving-image data.

The seamless roaming unit 540 has a function of a MobileIP communication, monitors network interfaces for availability, selects an optimum network interface when necessary, and performs data communication through the selected network interface.

A camera 660, which takes a live image, is connected to the delivery server 620, which comprises a high-bandwidth encoder 621 and a low-bandwidth encoder 622. An image signal generated by the camera 660 is supplied to the high-bandwidth encoder 621 and the low-bandwidth encoder 622. The high-bandwidth encoder 621 generates image data having higher quality than the low-bandwidth encoder 622.

In the above construction, when a user of the terminal 500 activates the web browser 510, the web browser 510 activates the application 520, which monitors bandwidths of currently used network interfaces by periodically inquiring of the seamless roaming unit 540 about the bandwidths.

Thereafter, when the user provides a manipulation input to the web browser 510 for requesting a webpage from the web server 610 for browsing, the web browser 510 accesses the web server 610, and acquires and displays the webpage. At this time, the web browser 510 is connected to the web server 610 through one of at least one available network interface in the seamless roaming unit 540 having a greater bandwidth.

When the user selects a certain item corresponding to a request for acquisition of an image taken by the camera 660, on a webpage displayed on the terminal 500, the application 520 notifies the player 530 of an URL of an encoder corresponding to the current bandwidth. Specifically, a value indicating a minimum bandwidth necessary for transfer of moving-image data delivered by the high-bandwidth encoder 621 is preset in the application 520 as a threshold value of the bandwidth. In addition, URLs of the high-bandwidth encoder 621 and the low-bandwidth encoder 622 are also preset in the application 520. When the current bandwidth is equal to or greater than the threshold value, the application 520 notifies the player 530 of the URL of the high-bandwidth encoder 621. When the current bandwidth is below the threshold value, the application 520 notifies the player 530 of the URL of the low-bandwidth encoder 622.

The player 530 transmits a request for acquisition of moving-image data through the seamless roaming unit 540, where the URL of which the player 530 is notified is designated in the request. Then, the request for acquisition of the moving-image data is sent to the delivery server 620, and the moving-image data representing an image taken by the camera 660 is delivered from the encoder designated by the URL.

For example, when communication is performed through the wireless LAN card 501, and the effective transfer rate is equal to or greater than the threshold value, moving-image data generated by the high-bandwidth encoder 621 is transmitted through the home agent 630 to the terminal 500, and the player 530 reproduces a live image based on the moving-image data on a real-time basis.

When communication through the wireless LAN card 501 stops, the seamless roaming unit 540 switches the network interface used for the communication, from the wireless LAN card 501 to the modem 502 for mobile telephone. Then, the seamless roaming unit 540 measures the effective transfer rate after the switching of the network interface, and passes the measured effective transfer rate to the application 520 when requested by the application 520.

In the case where the effective transfer rate through the modem 502 for mobile telephone is below the threshold value, the application 520 notifies the player 530 of the URL of the low-bandwidth encoder 622. Then, the player 530 outputs a request for acquisition of moving-image data, where the URL of the low-bandwidth encoder 622 is designated in the request. In response to this request, moving-image data generated by the low-bandwidth encoder 622 is transmitted through the home agent 630 to the terminal 500, and the player 530 reproduces a moving image based on the moving-image data.

As described above, when the connected network is changed, it is possible to appropriately switch the moving-image data on a real-time basis so as to have quality corresponding to the bandwidth through the switched network. In addition, in the above example, the terminal 500 determines the quality of moving-image data, and then designates moving-image data having the determined quality. Therefore, it is unnecessary to add a special function to the delivery server 620.

[Other Variations]

In the above embodiments, adjustment of quality of content and other operations which are performed when a used network is switched are explained. However, the present invention can also be applied to the cases where the circuit in an identical network is switched (e.g., from a high-speed circuit to a low-speed circuit).

The above processing functions can be realized by server computers and client computers. In this case, server programs and client programs are provided, where the server programs describe details of processing realizing the functions which the content servers should have, and the client programs describe details of processing realizing the functions which the terminals should have. When a server computer executes one of the above server programs, the processing functions of a content server according to the present invention are realized on the server computer. In addition, when a client computer executes one of the above client programs, the processing functions of a terminal according to the present invention are realized on the client computer.

Each of the server programs and the client programs describing the details of processing can be stored in a computer-readable recording mediums. The computer-readable recording mediums may be a magnetic recording device, an optical disc, an optical magnetic recording medium, a semiconductor memory, or the like. The magnetic recording device may be a hard disk drive (HDD), a flexible disk (FD), a magnetic tape, or the like. The optical disc may be a DVD (Digital Versatile Disc), a DVD-RAM (Random Access Memory), a CD-ROM (Compact Disc Read Only Memory), a CD-R (Recordable)/RW (ReWritable), or the like. The optical magnetic recording medium may be an MO (Magneto-Optical Disc) or the like.

In order to put the server programs and the client programs into the market, for example, it is possible to sell a portable recording medium such as a DVD or a CD-ROM in which each program is recorded. Alternatively, each client program can be stored in a storage device belonging to a server computer, and transferred from the server computer to the client computer through a network.

Each server computer which executes a server program stores the server program in a storage device belonging to the server computer. For example, the server program is originally recorded in a portable recording medium. Then, the server computer reads the server program from the storage device, and performs processing in accordance with the server program. Alternatively, the server computer may directly read the server program from the portable recording medium for performing processing in accordance with the server program.

Each client computer which executes a client program stores the client program in a storage device belonging to the client computer. For example, the client program is originally recorded in a portable recording medium, or transferred from a server computer. Then, the client computer reads the client program from the storage device, and performs processing in accordance with the client program. Alternatively, the client computer may directly read the client program from the portable recording medium for performing processing in accordance with the client program. Further, the client computer may sequentially perform processing in accordance with each portion of the client program when the client computer receives the portion of the client program from the server computer.

As explained above, according to the present invention, the priority is determined based on a numerical value related to an attribute of network interfaces, and communication is performed by using a network interface having high priority. Therefore, even when the communication condition is changed, it is possible to perform data communication through the currently optimum network interface.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communication control program which is executed by a computer and makes said computer perform a process for performing communication by use of a plurality of network interfaces, said process comprises the steps of:
(a) detecting at least one of said plurality of network interfaces which is currently available for communication;
(b) determining a network interface having a highest priority among said at least one of the plurality of network interfaces by referring to an interface information table in which numerical values related to a predetermined attribute of the plurality of network interfaces are set, and recognizing at least one priority of said at least one of the plurality of network interfaces based on the numerical values; and
(c) performing data communication through said network interface determined in step (b).

2. The communication control program according to claim 1, wherein said numerical values represent bandwidths of the plurality of network interfaces.

3. The communication control program according to claim 1, wherein said process further comprises the steps of,
(d) measuring an effective transfer rate through one of said plurality of network interfaces when data communication is performed through the one of the plurality of network interfaces, and
(e) updating one of said priorities of the one of the plurality of network interfaces based on the measured effective transfer rate.

4. The communication control program according to claim 1, wherein said process further comprises the steps of,
(d) measuring an effective transfer rate through one of said plurality of network interfaces when data communication is performed with a terminal through the one of the plurality of network interfaces, and
(e) transmitting the measured effective transfer rate to said terminal.

5. The communication control program according to claim 1, wherein location information items indicating locations from which content is delivered at different quality levels, respectively, and said process further comprises the steps of,
(d) acquiring one of the location information items corresponding to a bandwidth of said network interface determined in step (b), during data communication, and
(e) acquiring said content by designating one of the locations by the acquired one of the location information items.

6. A content delivery program which is executed by a computer and makes said computer perform a process for delivering content to a terminal in response to a request by the terminal for acquisition of the content, said process comprises the steps of:
(a) preparing and storing quality-management information indicating correspondences between bandwidths and quality levels of said content;
(b) determining a quality level of said content to be delivered to said terminal by referring to said quality-management information when bandwidth data indicating a bandwidth of a network to which the terminal is connected is received;
(c) generating said content at said quality level determined in step (b); and
(d) transmitting said content generated in step (c) to said terminal.

7. The communication control program according to claim 6, wherein said content is data representing a moving image, and is generated at said quality level by removing a portion of frames constituting the data, according to the quality level determined in step (b).

8. The communication control program according to claim 6, wherein said content is data representing sound, and is generated at said quality level by changing a sampling rate of the data according to the quality level determined in step (b).

9. The communication control program according to claim 8, wherein said sound is collected by a microphone.

10. The communication control program according to claim 6, wherein said content is data representing sound, and is converted into character data according to the quality level determined in step (b).

11. The communication control program according to claim 6, wherein said content is data representing a map, and is generated at said quality level by changing an amount of objects to be included in the data, according to the quality level determined in step (b).

12. The communication control program according to claim 11, wherein a plurality of priorities are assigned to a plurality of types of objects in advance, and at least one priority of the objects to be included in the data according to the quality level determined in step (b) is preset in said quality-management information.

13. A terminal for performing communication through a plurality of network interfaces, comprising:
said plurality of network interfaces which can be connected to a plurality of networks;
an available-interface detection unit which detects at least one of said plurality of network interfaces which is currently available for communication;
a network-interface selection unit which determines a network interface having a highest priority among said at least one of the plurality of network interfaces by referring to an interface information table in which numerical values related to a predetermined attribute of the plurality of network interfaces are set, and recognizing at least one priority of said at least one of the plurality of network interfaces based on the numerical values; and
a data communication unit which performs data communication through said network interface determined by said network-interface selection unit.

14. A content server for delivering content to a terminal in response to a request by the terminal for acquisition of the content, comprising:
a quality determination unit which stores in advance quality-management information indicating correspondences between bandwidths and quality levels of said content, and determines a quality level of said content to be delivered to said terminal by referring to said quality-management information when bandwidth data indicating a bandwidth of a network to which the terminal is connected is received;
a content generation unit which generates said content at said quality level determined by said quality determination unit; and
a content transmission unit which transmits to said terminal said content generated by said content generation unit.

15. A communication control method for performing communication in a terminal having a plurality of network interfaces, comprising the steps of:
(a) detecting at least one of said plurality of network interfaces which is currently available for communication;
(b) determining a network interface having a highest priority among said at least one of the plurality of network interfaces by referring to an interface information table in which numerical values related to a predetermined attribute of the plurality of network interfaces are set, and recognizing at least one priority of said at least one of the plurality of network interfaces based on the numerical values; and
(c) performing data communication through said network interface determined in step (b).

16. A content delivery method for delivering content to a terminal in response to a request by the terminal for acquisition of the content, comprising the steps of:
(a) preparing and storing quality-management information indicating correspondences between bandwidths and quality levels of said content;
(b) determining a quality level of said content to be delivered to said terminal by referring to said quality-management information when bandwidth data indicating a bandwidth of a network to which the terminal is connected is received;
(c) generating said content at said quality level determined in step (b); and
(d) transmitting said content generated in step (c) to said terminal.
